(19) United States
(12) Patent Application Publication
(10) Pub. No.: US 2006/0061770 A1
(43) Pub. Date: Mar. 23, 2006

(54) Heterodyning time resolution boosting method and system

(75) Inventor: David John Erskine, Oakland, CA (US)

Correspondence Address: James S. Tak;Assistant Laboratory Counsel, Lawrence Livermore National Laboratory, P.O. Box 808, L-703, Livermore, CA, 94551, US

(73) Assignee: The Regents of the University of California

(21) Appl. No.: 11/234,611

(22) Filed: Sep. 22, 2005

Related U.S. Application Data
(60) Provisional application No. 60/612,441, filed on Sep. 22, 2004.

(51) Int. Cl. G01B 9/02

(52) U.S. Cl. 356/484

(57) ABSTRACT

A method for enhancing the temporal resolving power of an optical signal recording system such as a streak camera or photodetector by sinusoidally modulating the illumination or light signal at a high frequency, approximately at the ordinary limit of the photodetector's capability. The high frequency information of the input signal is thus optically heterodyned down to lower frequencies to form beats, which are more easily resolved and detected. During data analysis the heterodyning is reversed in the beats to recover the original high frequencies. When this is added to the ordinary signal component, which is contained in the same recorded data, the composite signal can have an effective frequency response which is several times wider than the detector used without heterodyning. Hence the temporal resolving power has been effectively increased while maintaining the same record length. Multiple modulation frequencies can be employed to further increase the net frequency response of the instrument. The modulation is performed in at least three phases, recorded in distinct channels encoded by wavelength, angle, position or polarization, so that during data analysis the beat and ordinary signal components can be unambiguously separated even for wide bandwidth signals. A phase stepping algorithm is described for separating the beat component from the ordinary component in spite of unknown or irregular phase steps and modulation visibility values. This algorithm is also independently useful for analyzing interferograms or other phase-stepped interferometer related data taken with irregular or unknown phase steps, as commonly found in industrial vibration environments.

### I. CLAIM OF PRIORITY IN PROVISIONAL APPLICATION

This application claims priority in provisional application No. 60/612,441, filed on Sep. 22, 2004, entitled “Heterodyning Time Resolution Boosting” by David John Erskine.

The United States Government has rights in this invention pursuant to Contract No. W-7405-ENG-48 between the United States Department of Energy and the University of California for the operation of Lawrence Livermore National Laboratory.

### II. FIELD OF THE INVENTION

The present invention relates to the high speed recording of signals, and more specifically the use of modulation to produce heterodyned beats in optical signals, the detection of which enhances signal measurement at high resolution. The present invention also relates to the high resolution recording of optical spectra, and more specifically the use of interferometric modulation to produce heterodyned beats, the detection of which enhances spectral measurement at high resolution. Furthermore, the present invention relates to phase stepping data analysis, and more specifically a method for accurately determining the heterodyned beats signal under conditions of uncertain or irregular phase steps.

### III. BACKGROUND OF THE INVENTION

A streak camera is a high speed multichannel recording device in common use in science, capable of measuring light intensity in many (approximately 100) parallel spatial channels, over a time record that is made on its output phosphor screen. It works by converting light entering an input slit into electrons, and then sweeping this electron beam across the phosphor screen. The problem is that due to the blurring of the electron beam on the phosphor screen, the number of independent time bins, which is a way of describing the instrument's time resolving power, is limited to about 200. The resolving power will be even less if the input slit gap is wide (to allow more light intensity to enter) since that increases the blur on the phosphor screen. This is an insufficient resolving power for many science experiments, especially the measurement of shockwave phenomena performed at National laboratories.

The shockwave duration is very short-requiring very fast time resolution Δt. Yet there is usually a large interval in time between the several shockwave events that can happen in an experiment, such as reflections from interfaces, and different waves traveling through different thicknesses of sample. Secondly, there is usually a large uncertainty in time between the trigger time that began the experiment and the arrival of the shockwave. Hence a large record length T_{RL} is needed to insure capture of the shockwave in the data record. Hence this measurement demands a large number of independent time bins or resolving power Rₚ=(T_{RL}/Δt), usually larger than the 200 that a streak camera can provide.

Hence there is considerable need to increase the time resolving power of high speed recording instruments, particularly those that measure light intensity or other optical properties of a target such as its reflectance or transmittance, or the time varying Doppler shift in light reflected from the target. It is equivalent to say that we desire to increase the frequency response Δf_{D} (proportional to 1/Δt) of the detecting system, Rₚ=(T_{RL}/Δt)=(T_{RL}Δf_{D}).

Another important instrument problem besides poor resolving power is instrument distortions and nonlinearities. For example, the sweep speed of the electron beam writing the record in the streak camera can be non uniform, so that the time axis of the resulting record is non linear. This nonlinearity can itself vary non-uniformly across the spatial direction of the phosphor screen, so that a grid of timing fiducial marks, not just a line of such marks, is needed to fully remove the distortion. However, using valuable area on the phosphor screen for a fiducial grid removes channels available for the measurement. Secondly, there can be distortions in the experimental apparatus, external to the signal recorder, such as variations in path length of long optical fibers between the target area and the signal recorders, which can produce unknown shifts in the time axis of one channel relative to another.

Similarly, the measurement of an optical spectrum to high spectral resolution is an important diagnostic measurement in many areas of science and engineering, and the higher the resolution the better science. Here resolution, which often a colloquial term for the more proper term “resolving power” is the ratio (BW/Δλ) of spectral bandwidth BW to the smallest wavelength interval Δλ, that can be resolved. Typically, increasing the spectral resolution comes with a penalty of a larger dramatically more costly instrument. Hence there is great desire for a means for increasing spectral resolution without significantly increasing the cost or size of the spectrograph. Instrument distortions are also a significant problem with optical spectrographs. For example, air convection, changes in the shape of the beam as it falls on the spectrograph entrance slit, and thermomechanical drifts in position of optical components can cause the wavelength axis to shift, producing instrumental errors.

Interferometry is a common optical tool for precisely measuring many quantities in science and engineering, quantities that can be related to an optical path length (OPD) change. The raw output of an interferometer is an intensity of light. The intensity is interpreted to be a manifestation of a fringe, which is a sinusoidal variation of a signal as a function of a phase. Hence the goal in using an interferometer is to convert a raw intensity signal into a phase signal. Then the optical path length change is obtained from the phase change by multiplication by the wavelength of light λ.

In order to uniquely determine both the fringe phase and visibility (amplitude of the oscillating part) separate from any background nonfringing signal, multiple measurements of the interferometer are needed where the optical path length is incremented (“stepped”) by a roughly constant amount several times, usually a minimum of three, but often four. This has been called “phase shifting interferometry” or “phase stepping”. Phase stepping analysis is the process of converting a set of raw intensity data into a phase and visibility. Optimally the phases φ and visibilities γ are “regular”, which means that the visibilities are uniform and the phases are symmetrically positioned around the phase circle, e.g. three phases every ⅓ cycle (120 degrees), or four phases every ¼ cycle (90 degrees).

A serious problem with phase stepping analysis that affects its accuracy occurs when the phase steps or visibilities are irregular or unknown in their detailed value. This can occur in practical devices due to air convection or mechanical vibrations or drifts that change the optical path length beyond the intended value, or transducers that move an interferometer mirror (controlling the OPD) that produce a different displacement than the expected displacement. Changes in average fringe visibility can result when the phase wanders with time over a different range of angles for some exposures differently than other exposures. For example, a fringe that wanders ½ cycle in phase can have almost zero average visibility, almost cancellation, yet a fringe that wanders 0.05 cycle may change by only a few percent.

Furthermore, for some applications the phase step varies with the independent parameter being measured, such as time or wavelength, due to fundamental physics, so that even if the phase step is accurately implemented at the beginning of the experimental record it will change to a different value at the end of the record. So even if the phase configuration is regular at one point in the record, it is irregular for other portions. This can occur for example in a dispersive interferometer (interferometer and spectrograph in series) when the wavelength change across the recorded spectrum is large, since the interferometer phase step Δφ is a function of wavelength through Δφ=(ΔOPD/λ), in units of cycles. Hence a phase stepping analysis algorithm that is robust to irregular or unknown phases or visibilities is very useful.

### IV. SUMMARY OF THE INVENTION

One aspect of the present invention includes a method for increasing the temporal resolution of an optical detector measuring the intensity versus time of an intrinsic optical signal S₀(t) of a target having frequency f, so as to enhance the measurement of high frequency components of S₀(t), said method comprising: illuminating the target with a set of n phase-differentiated channels of sinusoidally-modulated intensity Tₙ(t), with n≧3 and modulation frequency fₘ, to produce a corresponding set of optically heterodyned signals S₀(t)Tₙ(t); detecting a set of signals Iₙ(t) at the optical detector which are the optically heterodyned signals S₀(t)Tₙ(t) reaching the detector but blurred by the detector impulse response D(t), expressed as Iₙ(t)={S₀(t)Tₙ(t)}\textcircled{×}D(t)=S_{ord}(t)+I_{n,osc}(t), where S_{ord}(t) is an ordinary signal component and I_{n,osc}(t) is an oscillatory component comprising a down-shifted beat component and an up-shifted conjugate beat component; in a phase stepping analysis, using the detected signals Iₙ(t) to determine an ordinary signal S_{ord,det}(t) to be used for signal reconstruction, and a single phase-stepped complex output signal Wₛₜₑₚ(t) which is an isolated single-sided beat signal; numerically reversing the optical heterodyning by transforming Wₛₜₑₚ(t) to Wₛₜₑₚ(f) and S_{ord,det}(t) to S_{ord,det}(f) in frequency space, and up-shifting Wₛₜₑₚ(f) by f_{M} to produce a treble spectrum W_{treb}(f), where W_{treb}(f)=Wₛₜₑₚ(f−f_{M}); making the treble spectrum W_{treb}(f) into a double sided spectrum S_{dbl}(f) that corresponds to a real valued signal versus time S_{dbl}(t); combining the double sided spectrum S_{dbl}(f) with S_{ord,det}(f) to form a composite spectrum Sᵤₙ(f); equalizing the composite spectrum Sᵤₙ(f) to produce S_{fin}(f); and inverse transforming the equalized composite spectrum S_{fin}(f) into time space to obtain S_{fin}(t) which is the measurement for the intrinsic optical signal S₀(t).

Another aspect of the present invention includes A computer program product comprising: a computer useable medium and computer readable code embodied on said computer useable medium for causing an increase in the temporal resolution of an optical detector measuring the intensity versus time of an intrinsic optical signal S₀(t) of a target having frequency f, so as to enhance the measurement of high frequency components of S₀(t) when the target is illuminated with a set of n phase-differentiated channels of sinusoidally-modulated intensity Tₙ(t), with n≧3 and modulation frequency f_{M}, to produce a corresponding set of optically heterodyned signals S₀(t)Tₙ(t), and a set of signals Iₙ(t) is detected at the optical detector which are the optically heterodyned signals S₀(t)Tₙ(t) reaching the detector but blurred by the detector impulse response D(t), expressed as Iₙ(t)={S₀(t)Tₙ(t)}\textcircled{×}D(t)=S_{ord}(t)+I_{n,osc}(t), where S_{ord}(t) is an ordinary signal component and I_{n,osc}(t) is an oscillatory component comprising a down-shifted beat component and an up-shifted conjugate beat component, said computer readable code comprising: computer readable program code means for using the detected signals Iₙ(t) to determine an ordinary signal S_{ord,det}(t) to be used for signal reconstruction, and a single phase-stepped complex output signal Wₛₜₑₚ(t) which is an isolated single-sided beat signal; computer readable program code means for numerically reversing the optical heterodyning by transforming Wₛₜₑₚ(t) to Wₛₜₑₚ(f) and S_{ord,det}(t) to S_{ord,det}(f) in frequency space, and up-shifting Wₛₜₑₚ(f) by f_{M} to produce a treble spectrum W_{treb}(f), where W_{treb}(f)=Wₛₜₑₚ(f−f_{M}); computer readable program code means for making the treble spectrum W_{treb}(f) into a double sided spectrum S_{dbl}(f) that corresponds to a real valued signal versus time S_{dbl}(t); computer readable program code means for combining the double sided spectrum S_{dbl}(f) with S_{ord,det}(f) to form a composite spectrum Sᵤₙ(f); computer readable program code means for equalizing the composite spectrum Sᵤₙ(f) to produce S_{fin}(f); and computer readable program code means for inverse transforming the equalized composite spectrum S_{fin}(f) into time space to obtain S_{fin}(t) which is the measurement for the intrinsic optical signal S₀(t).

Another aspect of the present invention includes a system for increasing the temporal resolution of an optical detector measuring the intensity versus time of an intrinsic optical signal S₀(t) of a target having frequency f, so as to enhance the measurement of high frequency components of S₀(t), said method comprising: means for illuminating the target with a set of n phase-differentiated channels of sinusoidally-modulated intensity Tₙ(t), with n≧3 and modulation frequency f_{M}, to produce a corresponding set of optically heterodyned signals S₀(t)Tₙ(t); an optical detector capable of detecting a set of signals Iₙ(t) which are the optically heterodyned signals S₀(t)Tₙ(t) reaching the detector but blurred by the detector impulse response D(t), expressed as Iₙ(t)={S₀(t)Tₙ(t)}\textcircled{×}D(t)=S_{ord}(t)+I_{n,osc}(t), where S_{ord}(t) is an ordinary signal component and I_{n,osc}(t) is an oscillatory component comprising a down-shifted beat component and an up-shifted conjugate beat component; phase stepping analysis processor means for using the detected signals Iₙ(t) to determine an ordinary signal S_{ord,det}(t) to be used for signal reconstruction, and a single phase-stepped complex output signal Wₛₜₑₚ(t) which is an isolated single-sided beat signal; processor means for numerically reversing the optical heterodyning by transforming Wₛₜₑₚ(t) to Wₛₜₑₚ(f) and S_{ord,det}(t) to S_{ord,det}(f) in frequency space, and up-shifting Wₛₜₑₚ(f) by f_{M} to produce a treble spectrum W_{treb}(f), where W_{treb}(f)=Wₛₜₑₚ(f−f_{M}); processor means for making the treble spectrum W_{treb}(f) into a double sided spectrum S_{dbl}(f) that corresponds to a real valued signal versus time S_{dbl}(t); processor means for combining the double sided spectrum S_{dbl}(f) with S_{ord,det}(f) to form a composite spectrum Sᵤₙ(f); processor means for equalizing the composite spectrum Sᵤₙ(f) to produce S_{fin}(f); and processor means for inverse transforming the equalized composite spectrum S_{fin}(f) into time space to obtain S_{fin}(t) which is the measurement for the intrinsic optical signal S₀(t).

Generally, suppose that S₀(t) is an intrinsic optical signal to measure as intensity versus time, which has a frequency spectrum S₀(f), which is the Fourier transform of S₀(t). Suppose we have a detection instrument system that has a net frequency response D(f) and associated time response D(t), which is its Fourier transform. These are called the “ordinary” or “conventional” instrument response, or detector blurring. These functions represent the net blurring that occurs in a conventional instrument. Then the conventional measurement detected at the instrument, called S_{ord}(t), is mathematically a convolution
S_{ord}(t)=S₀(t)\textcircled{×}D(t) Eqn. xx1
which in frequency space is a product
S_{ord}(f)=S₀(f)D(f). Eqn. xx2

The present invention enhances the ability of a detector to measure the high frequency components of a time varying signal S₀(t) by sinusoidally modulating it at a frequency f_{M} prior to its detection, and to do so at several values of modulation phase φₙ, where n is called a phase stepping index. The modulation process can be represented by a transmission function Tₙ(t):
Tₙ(t)=(0.5){1+γₙ cos(2πfₘt+2πφₙ)} Eqn. xx3
which varies sinusoidally versus the independent variable “t” and is phase shifted by φₙ, for the n^{th} detecting channel of k channels. The (0.5) factor is unimportant here. The symbol γₙ is called the visibility and represents the degree of modulation, which is ideally unity but in practice less than this. The present invention multiplies the intrinsic signal by Tₙ(t), prior to the blurring action represented by the convolution in the following equation for the n^{th} data channel:
Iₙ(t)={Tₙ(t)S₀(t)}\textcircled{×}D(t) Eqn. xx4
A heterodyning effect occurs between the sinusoidal component of Tₙ(t) and S₀(t), which creates up-shifted and down-shifted beat components. (The ordinary component S_{ord}(t) is also produced.) The beat components are scaled replicas of S(f), but shifted in frequency, up and down, by amount f_{M}. The up-shifted beat component is unlikely to survive detector blurring D(f). The down-shifted beat component in frequency space is:
W_{beat}(f)=(0.5)γS(f+f_{M})D(f) Eqn. xx5
The down-shifted beats manifest high frequency information moved optically toward lower frequencies, where they are more likely to survive detector blurring. The present invention measures these beats, and then numerically reverses the heterodyning process during data analysis to recreate some of the original high frequency information. This is done by shifting the frequencies upward by f_{M}, forcing the output to be purely real, and dividing out D(f) where appropriate.

Thus the present invention is capable of measuring frequencies near f_{M} at better sensitivity than the detector used without modulation. If f_{M} is chosen to lie on the shoulder of the ordinary response D(f) curve, then the effective frequency response of the instrument that combines the processed beat information with the ordinary signal, is expanded beyond D(f). Since resolving power is proportional to frequency response, the invention can improve (boost) the temporal resolving power of a detecting system, so that for the same record length a greater number of effective time bins are manifested.

In order to reverse the heterodyning on the beat signal component, the beats must be separated from the ordinary component. This is accomplished by taking multiple data Iₙ(t) and applying a phase stepping data analysis algorithm to combine them to form a single complex output signal expressing the beat signal. (The complex form is mathematically convenient because phase and visibility are naturally expressed as magnitude and angle of the signal in the complex plane, for a given t). An example of a phase stepping algorithm that works only for four data channels having ¼ cycle phase steps and uniform visibility γₙ, i.e. a regular phase and visibility configuration, is
Wₛₜₑₚ(t)={I₁(t)−I₃(t)}+{I₂(t)−I₄(t)} Eqn. xx6

The present invention solves the problem of how to analyze phase stepped data taken with irregular or unknown phases and visibilities, as well as those having regular phases and visibilities. The invention describes a phase stepping algorithm which works for the general case of any number of phase steps greater than two, whose detailed values for phase and visibility can be initially unknown, which can be irregularly or regularly spaced in phase and uniform or non-uniform visibility versus channel index n. The algorithm works best for long duration recordings so that the beat and ordinary signals can manifest different shapes and be distinguished from each other. A minimum of three (i.e. k>2) distinct modulation phases are needed to unambiguously separate the beat, conjugate beat, and ordinary components for any general intrinsic signal, including wide bandwidth signals that have frequencies from zero to some high value.

First the ordinary component (to be used later in signal reconstruction, i.e. “determined ordinary component”) is found and then removed from each member of the phase stepped data, so that the latter consists purely of an oscillatory component. This oscillatory component is the sum of the beat and the conjugate beat. (The conjugate beat is the complex conjugate of the beat signal, having opposite polarity frequencies.) To find the effective ordinary component, the weighted average of all the phase stepped data is found and called a “centroid”, and the magnitude squared of this centroid signal integrated over its duration is found and called “var”. The weights are adjusted to find the minimum in var, which occurs when the wobble in the centroid due to the oscillatory part is absent. The advantage of this method is that it is not necessary to know the phase angles or visibilities to calculate var, nor is it necessary to calculate a theoretical value for each input data. The object being minimized is not the difference between a theory signal and data signal. Instead, the object being minimized is a weighted sum of data. This part of the algorithm is called the “best centroid” algorithm.

Next, the conjugate beat signal is deleted from the oscillatory signal leaving an isolated beat component. Every real valued signal, such as the oscillatory component can be, consists of symmetrical parts, one having mostly positive, and the other having mostly negative frequencies, and there can be considerable overlap between them for a wide bandwidth signal. This makes it non-trivial to separate them (one cannot simply delete all negative frequencies). One must remove the conjugate beat signal before one can reverse the heterodyning, because it is not possible to translate a signal both up and down simultaneously. We define the conjugate beats to be the ones having the more negative frequencies.

The weighted sum of the oscillatory data set will be computed, but only after selective rotations and selective adjustment of the weights are applied to the individual oscillatory signals. The goal is to delete the net conjugate beats in the weighted sum while leaving a strong sum of plain beats. First the approximate phase step values are found through a dot product method. Then each individual oscillatory data signal is anti-rotated by those phase angles just found, so that plain (non-conjugate) beat components all point in approximately the same phase, and thus add constructively vectorally. Now we either adjust the weightings or apply selective further rotations of some of the channels, to cancel the conjugate beats in the sum, using the minimization of var described above to determine when cancellation occurs. However, the var is calculated in such a way that it is sensitive only to the conjugate beat and not the plain beat signal, such as by temporarily filtering the data restricting it to negative frequencies. After these steps the sum of oscillatory data will consists of a single complex signal manifesting the plain beats, ready for the heterodyning reversal to be applied.

The invention can perform optical spectroscopy, which is to measure an instrinsic spectrum S₀(ν), by using a fixed delay interferometer in series with a spectrograph. The interferometer acts as the modulator since it creates a sinusoidal transmission versus wavenumber ν, (where ν=1/λ, in units of cm⁻¹). The transmission of an interferometer having delay τ_{M} (optical path length difference between interferometer arms, units of cm) is
Tₙ(ν)=(0.5){1+γₙ cos(2πτ_{M}ν+2πφₙ)} Eqn. xx7
Let the spectral blur of a spectrograph on its detector be described by D(ν), with associated response in Fourier space as D(ρ), where ρ is the spatial frequency along the dispersion direction and has same units, cycles per cm⁻¹, or cm, as the delay τ_{M}. With the interferometer in series with a spectrograph, the detected spectrum is
Iₙ(ν)={Tₙ(ν)S₀(ν)}\textcircled{×}D(ν) Eqn. xx8
and the equation for the beat signal is
W_{beat}(ρ)=(0.5)γS(ρ+τ_{M})D(ρ) Eqn. xx9
Equations xx7, xx8, and xx9 are analogous to Eqns. xx3, xx4, and xx5 when the independent variable ν acts as t, delay τ_{M} acts as a modulation frequency f_{M}, and spatial frequency along dispersion direction ρ acts as f. Hence the same data analysis procedure can be used regarding phase stepping and reconstruction of the measured signal (reversal of heterodyning etc.).

### V. BRIEF DESCRIPTION OF THE DRAWINGS

The accompanying drawings, which are incorporated into and form a part of the disclosure, are as follows:

FIG. 1 shows an exemplary heterodyning detection system of the present invention using phase channels encoded by angle to measure sample transmission versus time.

FIG. 2 shows an exemplary heterodyning detection system of the present invention using phase channels encoded by wavelength to measure target reflectivity versus time.

FIG. 3 shows an exemplary heterodyning detection system of the present invention using phase channels encoded by position to measure signal time dependence.

FIG. 4A shows a method of producing sinusoidally modulated illumination using an acousto-optic device and interference employed in an exemplary embodiment of the present invention.

FIG. 4B shows a method of producing sinusoidally modulated illumination from a train of narrow pulses, employed in an exemplary embodiment of the present invention.

FIG. 5A shows a method of making polarization encoded phase channels employed in an exemplary embodiment of the present invention.

FIG. 5B shows a wide angle Michelson interferometer employed in an exemplary embodiment of the present invention.

FIG. 6A shows a single phase sinusoidal illumination with a Doppler interferometer employed in an exemplary embodiment of the present invention.

FIG. 6B shows a single phase sinusoidal illumination with a displacement interferometer in an exemplary embodiment of the present invention.

FIG. 7 shows an exemplary heterodyning detection system of the present invention which sinusoidally modulates a spectrum versus wavenumber with an interferometer.

FIG. 8A shows an exemplary signal under constant illumination and under periodic modulation.

FIG. 8B shows an exemplary step function under constant illumination and under periodic modulation.

FIG. 8C shows exemplary interferometer fringes under constant illumination and periodic illumination.

FIG. 9A shows a segmented mirror acting as an interferometer employed in an exemplary embodiment of the present invention.

FIG. 9B shows diffraction peaks in the optical field at the focal plane in an exemplary embodiment of the present invention.

FIG. 10A shows an example of sinusoidal illumination for three channels and its average.

FIG. 10B shows two examples of regular phase configurations, for three and four channels.

FIG. 10C shows three examples of irregular phase channel configuration.

FIG. 11 shows method steps for isolating the ordinary component in an exemplary embodiment of the present invention.

FIG. 12 shows a graph illustrating a path of center of gravity and the wobble in an unbalanced phase configuration as well as after balancing by an exemplary method of the present invention.

FIG. 13 shows method steps for canceling the conjugate beats in an exemplary embodiment of the present invention.

FIG. 14 shows alternative method steps for canceling the conjugate beats by adjusting weights in an exemplary embodiment of the present invention.

FIG. 15 shows a graph illustrating a readout path overlaying a two dimensional pattern.

FIG. 16 shows single-phase heterodyning of a narrow bandwidth signal in an exemplary embodiment of the present invention.

FIG. 17 shows single-phase heterodyning producing confusion between components in an exemplary embodiment of the present invention.

FIG. 18 shows unambiguous frequency shift direction under multiphase heterodyning in an exemplary embodiment of the present invention.

FIG. 19 shows heterodyning and blurring effects during signal measurement in an exemplary embodiment of the present invention.

FIG. 20 shows data analysis steps in recovering the signal spectrum in an exemplary embodiment of the present invention.

FIG. 21 shows desirable masks for the beat and ordinary components in an exemplary embodiment of the present invention.

FIG. 22A shows the composite frequency response prior to equalization employed in an exemplary embodiment of the present invention.

FIG. 22B shows the composite frequency response of FIG. 22A after equalization.

FIG. 23 shows that high frequency noise can be suppressed when using beat information as employed in an exemplary embodiment of the present invention.

FIG. 24 shows a frequency response using multiple modulating frequencies in an exemplary embodiment of the present invention.

FIG. 25A shows a single modulating interferometer in series with a spectrograph as employed in an exemplary embodiment of the present invention.

FIG. 25B shows use of multiple modulating interferometers in parallel as employed in an exemplary embodiment of the present invention.

FIG. 26 shows use of multiple modulating interferometers in series as employed in an exemplary embodiment of the present invention.

FIG. 27 shows a binary tree arrangement of multiple modulators in an exemplary embodiment of the present invention.

FIG. 28A shows the conversion of multiphase intensity data into a complex signal data in an exemplary embodiment of the present invention.

FIG. 28B shows an iterative method of reconstructing the signal in an exemplary embodiment of the present invention.

FIG. 28C shows a mathematical model for a heterodyning instrument in the box 550, “Model of Instrument,” of FIG. 28B in an exemplary embodiment of the present invention.

FIG. 29 shows details of box 551, “Suggest Answer,” of FIG. 28B in an exemplary embodiment of the present invention.

### VI. DETAILED DESCRIPTION

Encoding Phase-Differentiated Illumination Channels by Angle

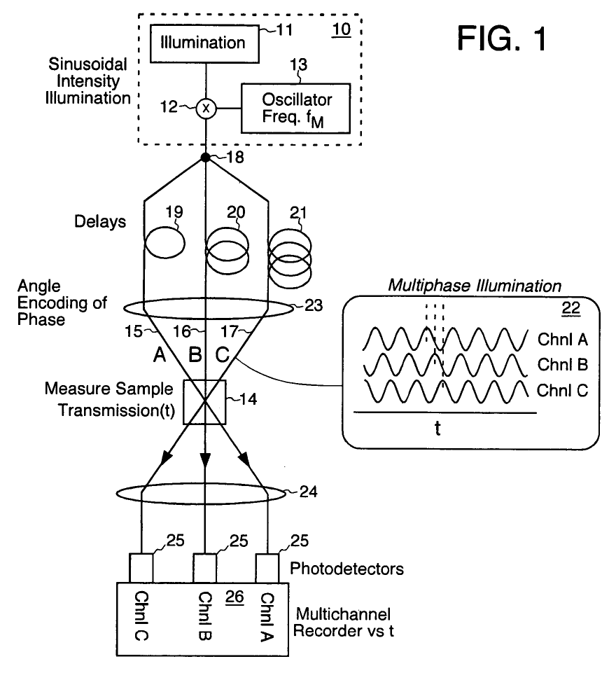

Turning now to the drawings, FIG. 1 shows an embodiment of the invention that uses multiple phase-differentiated illumination channels, e.g. 15, 16, and 17, encoded by angle to measure a sample 14 transmission (or reflectivity) versus time. A light source 10 which has a sinusoidal variation of intensity versus time at frequency f_{M} illuminates the sample. This could be created for example from a constant illumination source 11 by modulating light at an intensity modulator 12 controlled by a local oscillator signal 13 having frequency f_{M}. This f_{M} is referred to as a modulating or heterodyning frequency. The intensity modulator 12 could be implemented by an acousto-optical device commonly used in the laser sciences, which uses sound waves traveling in a crystal to diffract a beam of light away from a non-diffracted output into a diffracted output. Applying an oscillating voltage at frequency f_{M} to the acousto-optic element could create periodic modulation in the outputs.

The sinusoidal light 18 is then split into multiple channels labeled A (15), B (16), and C (17) where different relative delay times Delay_{A}, Delay_{B}, and Delay_{C} are imposed by delay lines 19, 20, and 21. These could be implemented by different lengths of optical fiber in which the light travels. The delay times are chosen so that the illumination intensity has different phases φ_{A}, φ_{B}, and φ_{C}, where a phase difference of 360 degrees corresponds to a delay time of one period of oscillation, which is 1/f_{M}. A phase difference in units of cycles is φ_{A}=f_{M}×Delay_{A}. Ideally the phases φ are evenly distributed around the phase circle. For the typical case of three phase channels the phases are ideally 0, 120, and 240 degrees, and for four channels, 0, 90, 180, and 270 degrees. The inset 22 depicts the intensity patterns of the different channels of multiphase illumination being shifted in time relative to each other. The case where the phases are irregularly spaced around the circle is discussed later.

The multiple illumination channels need to be distinguished from each other so that they can be detected by separate photodetectors 25 and recorded on separate channels of a multichannel recorder 26 versus time. FIG. 1 shows this channel separation accomplished by angle of incidence on the sample using a lens 23. The light from different channels is arrange to strike the lens at different positions. The lens converts different positions into different angles, which should largely be preserved as the light passes through or reflects from the sample. The receiving lens 24 then converts the angles or the transmitted (or reflected) light back into positional differences.

It is optimal that the transmission through the sample (or reflection from its surface) preserves the angular distinction between channels. However, some confusion between the separate channels is tolerated by this invention, as well as imperfect values for delays 19, 20, and 21, because the phase stepping algorithm described later can handle the irregular phase and/or visibility configurations that would result from such confusion.

Encoding Phase-Differentiated Illumination Channels by Wavelength

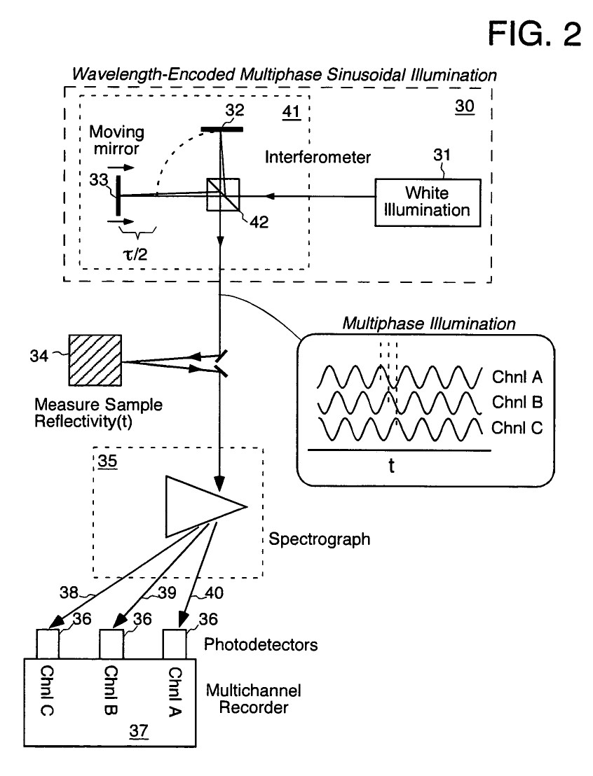

FIG. 2 shows an embodiment of the invention that uses multiple phase illumination channels 38, 39, and 40 encoding the different illumination channels by wavelength to measure a sample 34 reflectivity (or transmission) versus time. A source 30 of sinusoidal intensity light having different phases for different wavelengths provides illumination. Here the multiple channels A, B and C etc. can share the same path to and immediately from the sample, and the different phases are distinguished by wavelength. Light reflected from (or transmitted through) the sample passes through a spectrograph 35 which organizes the channels by wavelength into different photodetectors 36 and recorded into different channels by the recorder 37 versus time.

A moving mirror interferometer 41 is shown in FIG. 2 for producing sinusoidal intensity illumination having different phases for different wavelengths. A broad bandwidth illumination source 31 having constant intensity is modulated by the interferometer in a sinusoidal relation to the instantaneous optical path length difference (τ) between the two interferometer arms. The intensity after the interferometer is I(t)=0.5[1+cos(2πτ(t)/λ)]. (The optical path length difference is also called a delay.) The value of the delay or τ is twice the difference in the positions of the mirrors 32 and 33 from the interferometer beamsplitter 42. As either or both of the mirrors move it causes the value of τ to change sinusoidally with time (t). If one of the mirrors has a velocity ν, then the frequency f_{M} of modulation created is f_{M}=2v/λ. It is equivalent to think of this process as the light from the moving mirror being Doppler shifted, and when it interferes with the un-Doppler shifted light it create the modulation frequency.

To produce a high f_{M} requires a rapidly moving mirror, at least for the short duration of the measurement. For example for green light at λ=500 nm, a mirror velocity of 100 m/s produces f_{M} of 400 Mhz, and 300 m/s (the approximate speed of sound in air) produces 1.2 GHz. The moving mirror could be a reflective piece of thin foil or lightweight reflective plastic film accelerated over a short distance by a puff of compressed air, or the small explosion of a spark, or a mirror on a PZT transducer with a pulse of high voltage applied. A shock wave could be created in the mirror that moves the mirror's reflective surface at very high speeds (several km/s). (The mirror may be destroyed in the process.) An additional folding mirror and window could protect the rest of the interferometer from debris from the moving mirror.

Wavelength Dependent Phase

When using an interferometer 41 for modulation as shown in FIG. 2, the modulation phase, φ=τ/λ, will naturally vary with λ rapidly when the gross value of τ is large. This makes it easy to obtain any desired phase by using very slightly different wavelengths. For example if τ is 0.5 mm and λ=500 nm, then the absolute value of the phase is φ=1,000, so then a half cycle of additional phase shift (ie. 180 degrees) occurs when λ changes by one part in 2,000. A spectrograph of the required spectral resolution, approximately 4000, are commercially available. Smaller τ would produce smaller wavelength intervals, requiring even lower resolution spectrographs.

Irregularity from Phase Drifts Over Long Time

For the interferometric means 41 of generating modulation as shown in FIG. 2, there is a slight wavelength dependence to f_{M}, and this can cause the channel phases to drift linearly with time relative to each other during the measurement. This can take them from an initial regular configuration to an irregular one. For example, four channels starting at 0, 90, 180 and 270 degrees at time zero becoming 0, 91, 182, and 273 degrees at the end of the measurement. Fortunately, the phase stepping algorithm described later handles irregular phases. Secondly, if this drift is large, the measurement data can always be subdivided into short sections where within each the drift is manageably small. These data are processed separately, and then concatenated to form a final result over the full duration.

The amount of phase drift Δφ_{drift} over the measurement duration T due to a maximum spread Δλ in channel wavelengths and an average wavelength λ can be calculated from Δφ_{drift}=(Δλ/λ) (T f_{M}). Note that (T f_{M}) is the number of cycles of illumination modulation passing during the measurement. For example, if (Δλ/λ) is 1 part in 1000 and (T f_{M}) is 250 cycles then the phase drift is ¼ cycle, so that four wavelength channels originally at 0, ¼, ½, and ¾ cycles phase difference (ordered long to shorter wavelengths) would end at 0, (¾)(¼), (¾)(½), and (¾)(¾) cycles, if the mirror is moving toward the beamsplitter 42 to decrease τ with time. If the mirror is moving to increase τ, then the polarity of the phase drift is positive, and the final phases would be 0, ( 5/4)(¼), ( 5/4)(½), and ( 5/4)(¾) cycles.

Wide Angle Interferometer

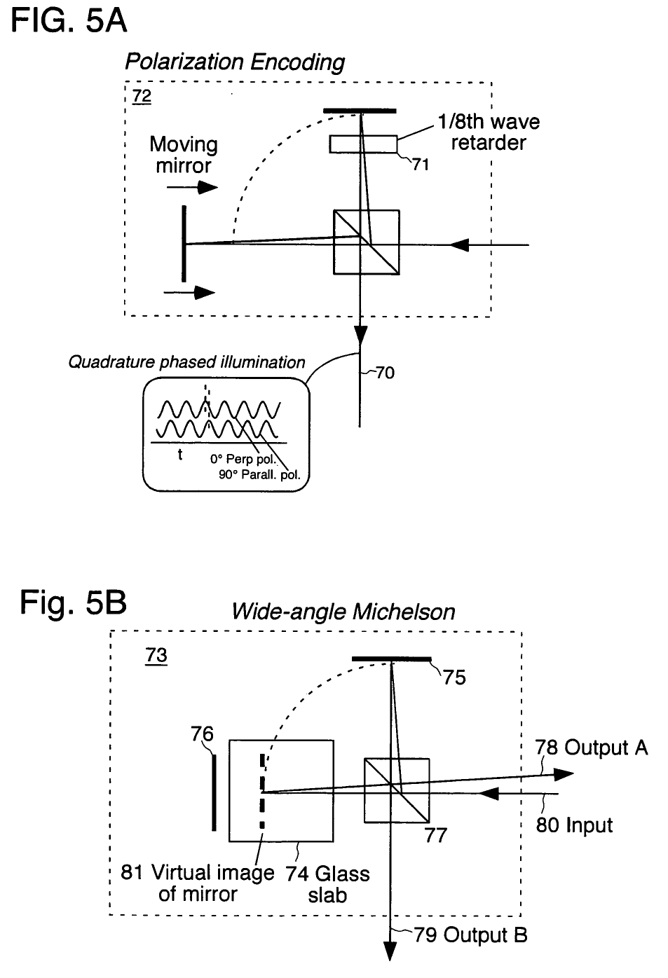

The interferometers in these schemes can be made to have an angle-independent delay useful for obtaining good visibility interference from extended sources. An example design is the wide angle Michelson design 73 of FIG. 5B. The delay is made angle independent by inserting a glass slab 74 called an etalon in the longer delay arm and moving the mirrors 75 and 76 such that the virtual image 81 of 76 is superimposed with 75 by the beamsplitter 77. The outputs 78 and 79 are complementary (out of phase by ½ cycle) so that their sum equals the input 80. Other schemes for creating this superimposing condition, such as using curved mirrors or lenses, are described in this author's patent U.S. Pat. No. 6,115,121 “Single and Double Superimposing Interferometer Systems”.

Acousto-Optic Modulator

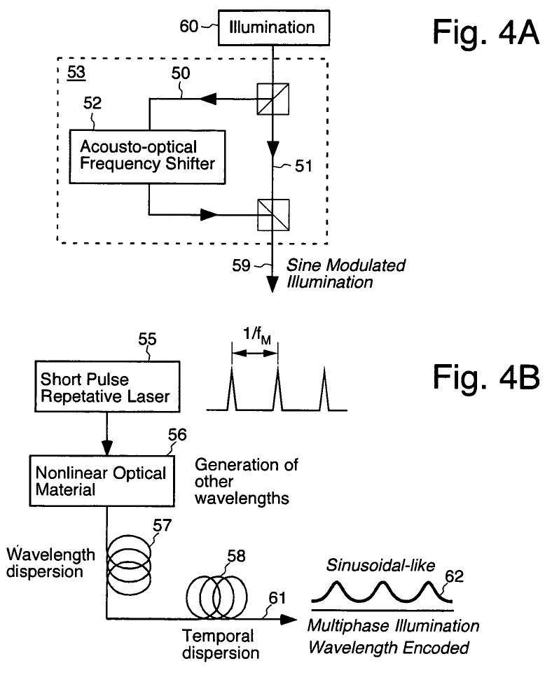

FIG. 4A shows an alternative method of making sine-modulated illumination from a source 60 by replacing the moving mirror 33 of FIG. 2 with an acousto-optic frequency shifting device 52 in one arm 50 of an interferometer 53. The frequency shifted light 54 is recombined to interfere with the light from the other interferometer arm 51 to create sinusoidal time varying illumination 59. The acousto-optic device 52 typically consists of a material in which sound waves travel. The sound waves locally change the refractive index or surface height so that incident light passing through or reflecting from the material is diffracted away having a slightly different optical frequency, equivalent to imparting a Doppler shift on the light as if scattered from an object moving at the speed of the sound waves. (It is useful to think of the light scattering off the phonons, which are the quanta of sound energy.) If the scattering angle is nearly head-on, then effectively, this is a means of creating a moving mirror similar to mirror 33 moving at the speed of sound in the crystal, which can be of order 1000 m/s, much higher than the speed of sound in air. This could create modulation frequencies f_{M} of order 4 GHz.

Sine-Illumination from a Train of Short Pulses

FIG. 4B shows a method of making sinusoidal-like illumination 61 and 62 from a train of narrow pulses, such as from a repetitively pulsed laser 55, using a temporally dispersive system 58. This could be a multi-mode optical fiber which has a different propagation speeds for different ray angles of light entering the fiber, and the different ray angles could be generated by a lens. This broadens the initially narrow pulses. If the broadened pulsewidth is similar to the laser repetition period, then the intensity variation can be approximately sinusoidal. (There may be a constant background intensity, so the visibility of the output modulation 62 may be less than unity.)

To use output 61 as the source 30 in the multiphase wavelength encoded scheme of FIG. 2, other wavelengths need to be applied as additional sources 55, or generated nonlinearly at 56 from a single source. Applied wavelengths could come from other laser systems synchronized to the same repetition period. Self-generated wavelengths could from passing the laser light 55 through a nonlinear optical material 56, after focusing it with lens to make it intense. The nonlinear optical material generates new wavelengths from the original wavelengths by processes such as self-phase modulation or 2nd or 3rd harmonic generation.

To create different modulation phases φ for different wavelengths, the light could be sent through a wavelength dispersive system such as a long optical fiber 57. The wavelength dependence of the fiber glass refractive index will delay some wavelengths relative to others, creating the phase difference. It is possible that the wavelength and temporal dispersion functions could be accomplished by the same fiber. If not, and if the wavelength dispersive fiber 57 is a single-mode fiber, then it practical to have fiber 57 precede any multimode fiber 58, rather than the converse, since it would be inefficient to try to inject a single-mode fiber with a multimode light beam.

Suppression of Harmonics of F_{M}

An imperfect sinusoidal variation of output 62, such as due to insufficient temporal broadening, can manifest harmonics to f_{M} at 2f_{M}, 3f_{M} etc., (and their conjugates at negative frequencies −2f_{M}, −3f_{M} etc.) which could generate additional beat components potentially confusing with the fundamental beat component. However, certain choices for channel phases can allow vector cancellation of some beat harmonics during analysis, while preserving the fundamental beat. Or it can allow preserving a beat harmonic while canceling the fundamental, such as the 2nd harmonic at 2f_{M}, which could be a way of performing a multiple frequency heterodyning without building a separate illumination source dedicated to producing modulation at 2f_{M}.

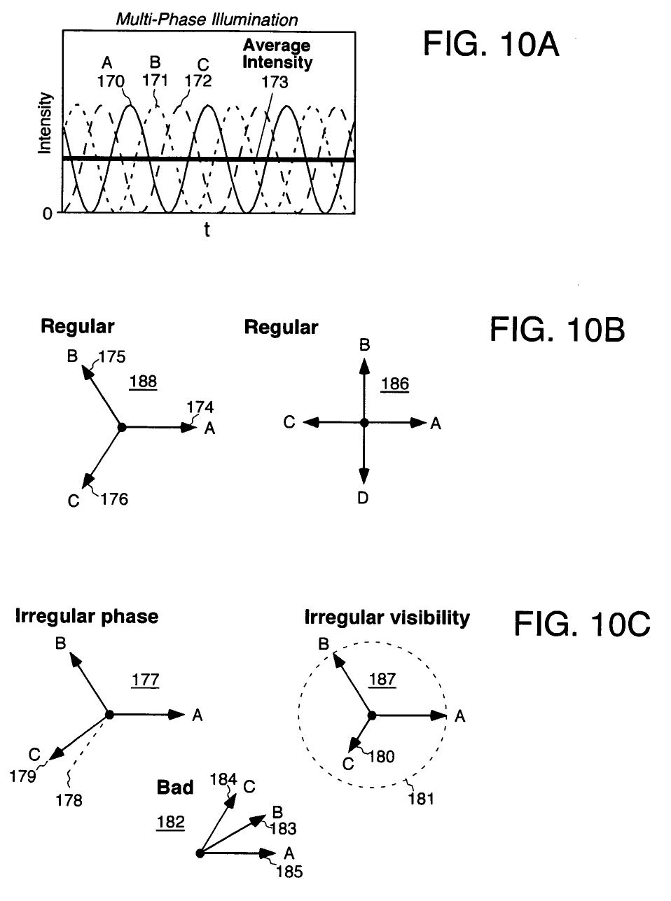

If the phase step between channels for f_{M} is called Δφ, then its value for the 2nd and 3rd harmonics will be 2Δφ and 3Δφ etc. Consider the example of a regular configuration of five channels of Δφ=⅕ cycle interval. This choice allows vector cancellation of the 2nd and 3rd harmonics during the same rotations used in analysis that aligns the fundamental. Other choices also work, and we will present a general rule in a moment. It is illustrative to work through this specific example. We start with the fundamental's phase configuration for the five channels of {φ_{A}, φ_{B}, φ_{C}, φ_{D}, φ_{E}}=0, ⅕, ⅖, ⅗, ⅘ cycles. Think of these as vectors pointing in all directions evenly around the circle all starting from the origin like the spokes of a wheel, similar to FIG. 10C but with five vectors instead of four. If we performed the vector sum now, we would get zero, which is not the intended result. So we first anti-rotate these vectors so that they point in the same direction, the direction of 0 phase, prior to their vector summation. The required set of rotation is Rot={0, −⅕, −⅖, −⅗, −⅘}, since adding these to the original phases produces {0, 0, 0, 0, 0}. Now when we add the beat signals from all channels together they will add constructively to form a strong signal, rather than destructively.

The intent is that during these same operations of rotation and summation, the harmonics, the conjugates of the harmonics, and the conjugate of the fundamental, will add destructively with themselves (ie. cancel) so that the fundamental is the only significant component in the final result. Let us examine to see if that is true. The initial configuration of the 2nd harmonic is {0, ⅖, ⅘, 6/5, 8/5}. Under the same rotation Rot, the set becomes {0, ⅕, ⅖, ⅗, ⅘}, which vector cancels because the phases are evenly distributed around the circle. Similarly, the 3rd harmonic set starts as {0, ⅗, 6/5, 9/5, 12/5} cycles and becomes under rotation of Rot the set {0, ⅖, ⅘, 6/5, 8/5}, which also vector cancels. And the conjugate of the fundamental, which is a harmonic at negative frequency −f_{M} and starts as {0, −⅕, −⅖, −⅗, −⅘}. Under the rotation Rot it becomes {0, −⅖, −⅘, − 6/5, − 8/5}, which also cancels. Similarly, the conjugate harmonics at −2f_{M}, and −3f_{M} also cancel. However, some harmonics will not cancel, such as the 4th conjugate harmonic at −4f_{M}, which begins as {0, −⅘, − 8/5, − 12/5, − 16/5}. Under rotation Rot this becomes {0, − 5/5, − 10/5, − 15/5, − 20/5} which is equivalent to {0, 0, 0, 0, 0} because phases are periodic every integer cycle. This means that the −4th harmonic will contribute a signal to the final result and possibly confuse the interpretation of the fundamental beat signal. Similarly for the 6th, −9th, 11th, −14th etc. harmonics will also contribute. Fortunately, the harmonics of a periodic function tend to be much smaller in magnitude than the fundamental.

We can state the general relationship. Let h be the harmonic number (which can be negative) such that the modulation frequency is f=h f_{M} and k the number of phase channels that evenly divide a circle so that every phase interval is 1/k. Then when rotating to solve for the fundamental every harmonic will cancel except for those where (h−1) is a multiple of k or −k. Thus h=(±jk)+1 where j are all the integers, and the absolute value of h is |h|=jk±1. Hence, in the above example, k=5 and the harmonics which do not cancel are |h|=4, 6, 9, 11, 14 etc. But the 2nd and 3rd harmonics do cancel, and these are often larger than the higher order ones.

Instead of rotating to align the fundamental, we can choose a different set of rotations to align any harmonic, to process the heterodyning signal that comes from other modulation frequencies which are multiples of f_{M}. This a means of using the broadened pulse train as a source of multiple heterodyning frequencies f_{M1}, f_{M2} etc., which further increases the effective frequency response of the measurement. If g is the order of the harmonic to be aligned (with the fundamental and its conjugate being g=±1), then every harmonic will cancel except for those where (h−g) is a multiple of k or −k. Thus the absolute value of the harmonics which do not cancel is |h|=jk±g, where j is the set of integers. So if k=5 and we align to the 2nd harmonic, then g=2 and the uncancelled harmonics will be 3, 7, 8, 12 etc.

Generally, if the smaller order harmonics h=2, 3, 4, are present in greater amplitude than harmonics at h>5, which is often the case for a near-sinusoid, then it is advantageous to have larger k. But large k may be expensive or impractical to implement in hardware, so there is a tradeoff to consider. This phase stepping analysis method of canceling harmonics can also be applied by analogy to fringing spectra data taken with a low-finesse Fabry-Perot of this inventor's patent U.S. Pat. No. 6,351,307 “Combined Dispersive/Interference Spectroscopy for Producing a Vector Spectrum”. The equation |h|=jk±g is an improved method of determining what effect a choice of k will bring on the suppression of harmonics. By analogy we can use the harmonics of the Fabry-Perot transmission versus wavenumber (1/λ), having a fundamental periodicity of delay τ, as a means of implementing a multiple delay interferometer that effectively has other delays of 2τ, 3τ, etc., by processing the phase stepped data with different schedules of channel rotations to isolate different harmonics.

Polarization Encoding of Phase

FIG. 5A shows a method of making polarization encoded sinusoidal illumination 70 using a retarder 71 internal to an interferometer 72, otherwise similar to interferometer 41 of FIG. 2. Suppose a ⅛ wave retarder is used. This makes the interferometer delay τ longer by ¼ cycle, and hence the modulation phase 0.25 cycle different for one polarization compared to the other. The directions of the polarization are defined by polarizers (not shown) placed before photodetectors 36 of each channel, so that one set of channels could detect a phase 0.25 cycle different than another set. When used together with the wavelength encoding scheme, this doubles the number of available phase channels, because the 0 and 0.5 channels can become 0.25 and 0.75, making a regular set of four at interval Δφ=0.25 cycle.

Polarization encoding could also be used in the angle encoding scheme of FIG. 1 to allow doubling the number of independent phase channels, by placing a matched pair of polarizers in each channel both before and after the sample 14. Channels neighboring in angle could have opposite polarizations, to improve rejection of a neighbors signal leaking into the intended channel.

Laser Mode-Beating for Creation of Sine-Illumination

A source of sine modulated intensity illumination could be a laser which has two of its longitudinal modes oscillating simultaneously. This will naturally produce a sinusoidal intensity with a frequency f_{M}=c/2 L where L is the laser cavity length, due to beating between two frequency modes. Due to the requirement that an integer number of wavelengths (λ=c/f) fit inside the cavity roundtrip distance (2 L) of a laser, the frequency spacing between laser modes is c/2 L. To encourage the laser to oscillate in just two longitudinal modes, one can alter the gain profile of the laser, such as by inserting optical elements, to restrict a normally very wide gain profile to be just wide enough for two modes.

Irregular Phase

Minor confusion of channels, such as from an imperfectly specular reflective surface, or a cloudy transmissive sample, does not prevent the measurement for this invention. It can cause a decrease in the signal visibility (ie. the amplitude of the oscillator portion of signal) and/or a change in phase for some channels as the partial combine vectorally. This can form an irregular phase and/or visibility configuration. This invention presents an algorithm handling such irregular phase or visibility configurations. (However, these irregular situations have smaller signal to noise ratios than the regular phase and visibility configurations.)

Heterodyning Velocity Interferometer

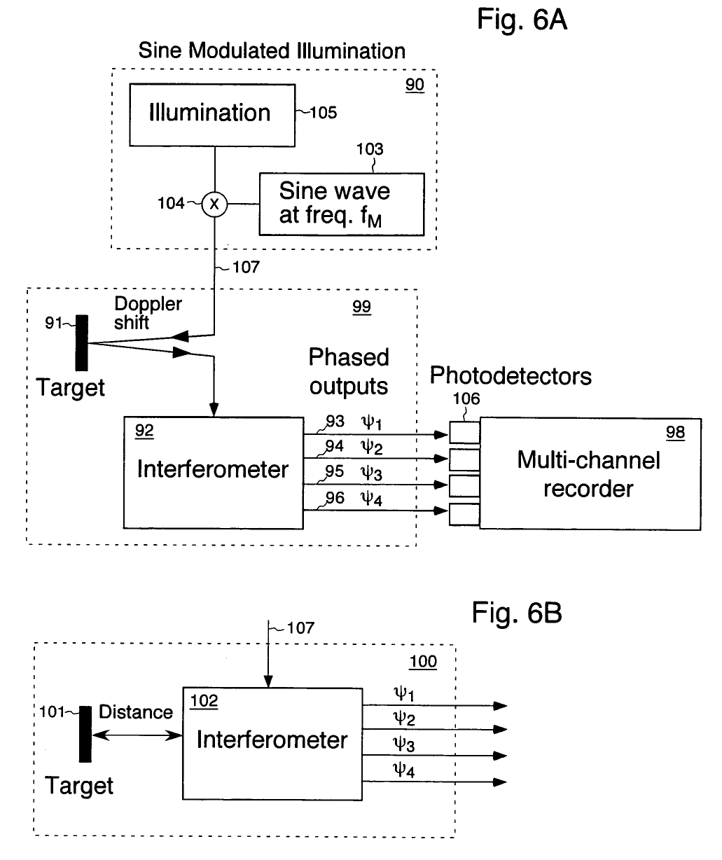

FIG. 6A shows an embodiment of the invention that uses a multiphase velocity interferometer 92 to measure the Doppler velocity of a target 91. The distinction here with the embodiments of FIG. 1 or FIG. 2 is that the detecting apparatus (the interferometer 92) provides multiples phases, therefore the illumination system 90 can be single phased. (The illumination could also be multiphased, but this requires more complicated hardware.)

The motivation is to improve the time resolution in measuring the velocity behavior of a target 91, particularly one that is moving abruptly. Velocity interferometer systems, often called “VISAR”s, are in use in national laboratories to measure the velocity response of targets to shockwave loading. They use laser illumination that is reflected off the moving target surface, and pass the reflected light through an interferometer. These do not sinusoidally modulate their illumination. The multiple phased outputs of the interferometer manifest fringes, which are detected and recorded, either by discrete photodetectors or all channels by a streak camera. The Doppler velocity of a target creates a proportional phase shift in the recorded fringes.

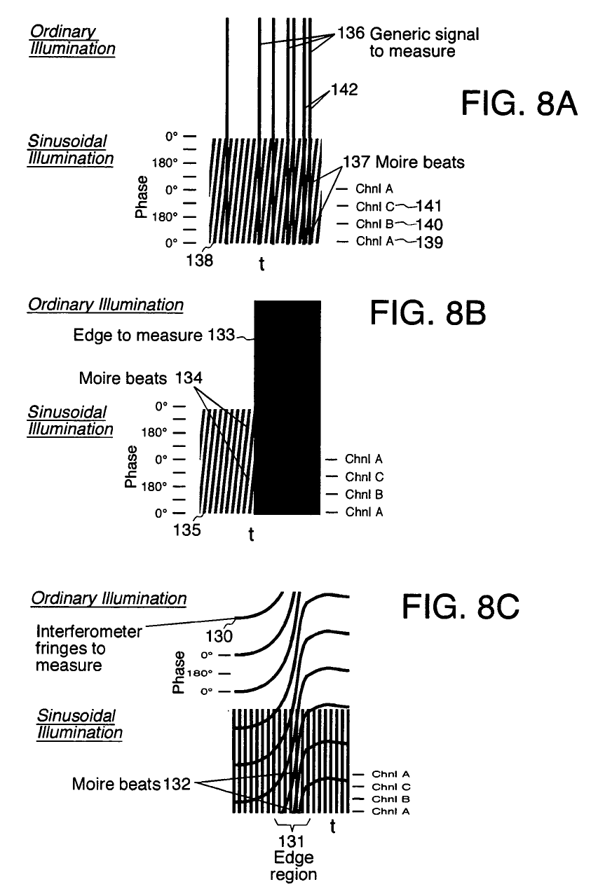

The problem with the current VISARs is that the limited time resolution of the photodetectors is not fast enough to detect the rapid passage of fringes during the shock. The result is that these fringes blur away, to greatly reduced or zero visibility, during the most important (for science) time region. An example of an ideal VISAR signal, having perfectly fast detector response, under constant illumination is curve 130 in the upper portion of FIG. 8C. The region where the signal changes abruptly (the shockwave) is labeled 131 “Edge Region”. This is where the fringes move most rapidly, and where they would blur away if a realistic detector, one having a limited frequency response, were used. A goal of the measurement is to accurately measure the arrival time of the shock. Frustratingly, exactly where the fringing information is needed the most in the record is where it is usually lacking.

The invention solves this problem by sinusoidally modulating the illumination by the amplitude modulator 104 and oscillating signal 103 at frequency f_{M}. The modulator or modulated illumination source could be implemented by the variety of other schemes for producing sinusoidal illumination discussed in this document. By modulating the illumination at f_{M}, the portions of the VISAR signal having high frequency at f are heterodyned to lower frequency beats at (f−f_{M}). These lower frequency beats are much more resolvable by the photodetectors 106 and recording system 98. The appearance of these beats 132, also called a moiré pattern, is shown in the lower portion of FIG. 8C.

FIG. 6B shows a similar embodiment that measures target distance changes instead of velocity changes, by placing the target 101 internal to the interferometer 102 cavity, as a mirror, so that a fringe shift is proportional to target displacement. The displacement detecting interferometer system 100 replaces the velocity detecting version 99.

Spectral Measurement

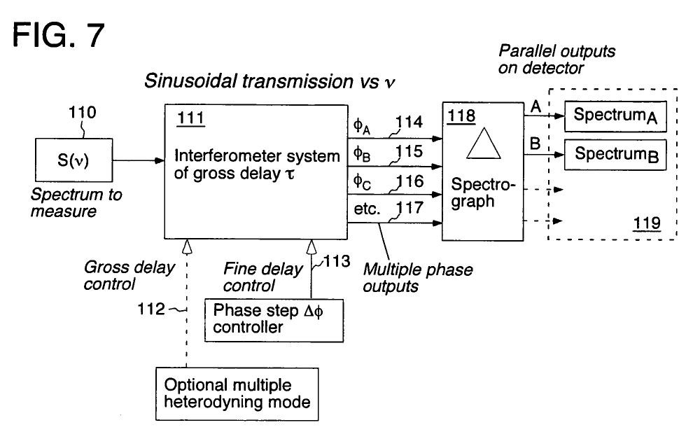

FIG. 7 shows an embodiment of the invention that measures the spectral properties of an input light signal 110 called S(ν) by combining an interferometer 111 with a spectrograph 118. This is a means of measuring the spectrum to higher resolution than with the spectrograph used alone, by the process of heterodyning, analogous to the heterodyning process also described in this document to increase time resolution of time recordings. For the spectral measurement, the interferometer has a transmission function T(ν,φ)=(½)[1+γ cos(2πτν+2πφ)], which is sinusoidal versus wavenumber ν=1/λ. The interferometer delay τ is analogous to the sinusoidal modulation frequency f_{M} in the time resolution boosting embodiments, such as FIG. 1. The delay sets the spatial frequency of this sinusoid versus the dispersion parameter ν of the spectrograph 118. (The wavelength λ is the more familiar dispersion parameter, but the wavenumber ν is more mathematically convenient, because T(ν,φ) is precisely sinusoidal with that variable.) The spectrograph 118 and the recorded spectrum 119 it produces is analogous to the time recorder 26, and the wavenumber ν is analogous to the time variable t. The spectrum to be measured 110 S(ν) is analogous to the sample 14 Transmission(t) or sample 34 Reflectivity(t) to be measured versus t.

The generic interferometer system 111 produces multiple output channels 114, 115, 116 etc. having different phases φ, and which could have different visibilities γ. The phase φ is just the detailed value of the delay τ relative to some gross value τ₀, as τ=τ₀+φλ, if φ is in cycles.

An optional phase stepper 113 can change the phase of all the output channels by the same amount Δφ such as by moving an interferometer cavity mirror. Thus even an interferometer having only two simultaneous outputs can use sequential measurements while changing Δφ to measure φ at a greater variety of phases, effectively increasing the number of channels. For example, a first data set might be at 0 and ½ cycles, a second data set at Δφ=⅙ would produce ⅙ and 4/6 cycles, and a 3rd at Δφ=⅓ would produce 2/6 and ⅚ cycles, effectively providing six channels with 60 degrees of phase interval.

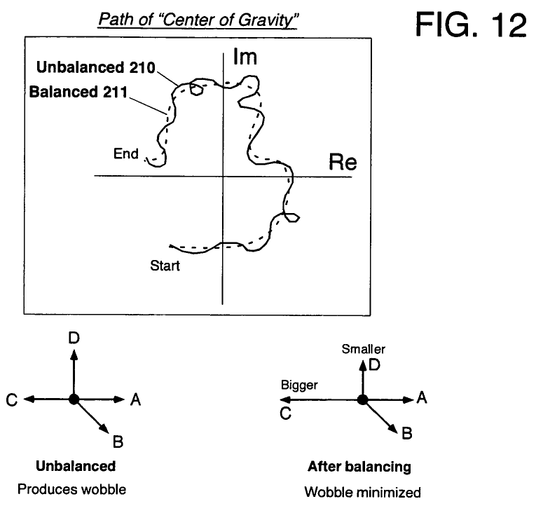

The gross delay can optionally be changed by a large amount (many wavelengths), to implement a multiple “frequency” heterodyning scheme (where τ sets the “frequency”). (Remember that τ sets the spatial frequency along the spectrum when plotted versus ν.) This could involve taking multiple data sets in sequence while changing the delay of a single interferometer from τ₁ to τ₂ to τ₃ etc. if the input spectrum S(ν) is constant, or using multiple interferometers simultaneously viewing the same source, each having different values of delay τ₁, τ₂, τ₃ etc., or a single interferometer whose field of view as it is imaged along the spectrograph slit is subdivided into segments having different delay values. The latter embodiment is described in FIG. 12A and FIG. 12B of U.S. Pat. No. 6,351,307 by this inventor.

Interference by Segmented Optics

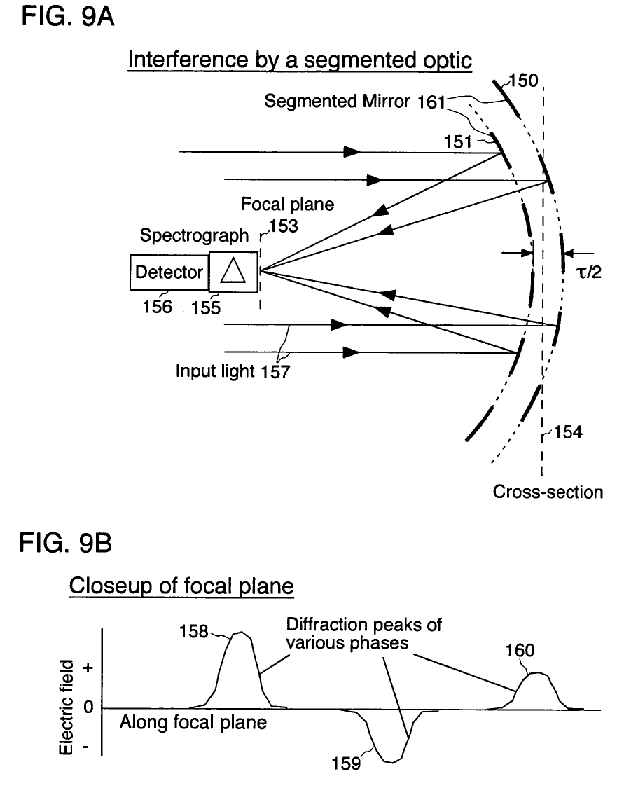

FIG. 9A and FIG. 9B show an example of an interferometric system that can produce multiple phase outputs 158, 159, 160 etc., which could have a variety of phases and visibilities. Today many telescope mirrors are constructed of segments, and these segments are mounted on translators that adjust their position so that the phase of the wavefront is accurately controlled, usually to compensate for wavefront distortions caused by the atmosphere. This is called adaptive optics. In the invention, the segmented optic 161, which is a mirror but could in principle also be a transmissive optic, has some of its segments 150 and 151 displaced by large distance (large compared to a wavelength) so that there is a optical path difference τ between one set of segments 150 and another set 151 (a displacement of τ/2 if the mirror reflects normally), as the input light 157 travels to a focal plane at 153. This could be implemented by changing the adaptive optics software to implement a gross displacement between some segments while otherwise stabilizing the detail value of the final wavefront to correct for atmospheric distortion as before. Then for those wavelengths where τ/λ is a whole number, the wavefront from every segment will have the same phase and interfere constructively, and the focal spot at the focal plane 153 will appear as normal (as if τ=0). This can be considered analogous to the in-phase output of a Michelson interferometer where the two arms constructively interfere.

For those wavelengths where τ/λ is an integer and a half, there will be a 0.5 cycle phase shift between the wavefront from one set 150 of segments and another set 151. (This will create the same set of diffraction peaks at the focal plane 153 as if the displacement τ was only λ/2.) In general this will create an arbitrarily complicated pattern of peaks 158, 159, and 160 etc. in the electric field versus position across the focal plane, governed by the laws of diffraction, which can be in a different location as the normal in-phase peak (not shown). These peaks are roughly analogous to an out-of-phase output of a Michelson interferometer, except that the phase may be different from exactly 0.5 cycle. In general, the spectral behavior of the field at the focal plane will follow a sinusoidal relation I(y)[1+γ(y) cos(2πτν+πφ(y)) ] versus delay, wavenumber and phase, as described earlier but could have a more complicated spatial dependence for the visibility and average intensity I(y), where y is position along the focal plane (which is put along the spectrograph slit length).

These out-of-phase peaks can have arbitrary amplitudes and phases relative to each other and the in-phase peak, and hence the segmented mirror is an example of an interferometric system 111 with gross delay τ having a variety of phases and visibilities. When the light at the focal plane 153 is sent into a spectrograph 155 recorded by a detector 156, then fringing spectra analogous to 119 are formed at the detector 156.

It is useful to have these spectra sufficiently separated on the focal plane so that they are not confused by falling on the same detector pixels. And it can be useful to have a few but intense peaks, so that light is concentrated on a few pixels. By the laws of diffraction, the height of the diffraction peaks 158, 159, and 160 etc. relative to their background is improved when the displaced 151 and undisplaced 150 segments are arranged to alternate periodically across the cross-section of the mirror 154, like a diffraction grating with an extremely high order (that is, the number of wavelengths between “grooves” is very large). The separation between peaks 158 and 159 will increase when the segment spatial frequency across the cross-section 154 is increased. This cross-section 154 is in the same direction as the spectrograph slit, that is, perpendicular to the spectrograph 155 dispersion direction, which is out of the page. The arrangement of segment displacements along a different mirror cross-section parallel to the dispersion axis would ideally have no periodicity, that is, all the segments would be at the same displacement. The detailed (on a wavelength scale) value of each segment's surface shape and mirror coating reflectivity could be sculptured to maximize the energy sent into a few diffraction peaks, analogous to blazing the grooves or apodizing a diffraction grating. The segmented optic could be made with transmissive elements, such as by having alternating glass sections of different length or refractive index.

Other Means of Channel Separation

Other means of separation include wavelength, or polarization, and are discussed further below. The various means of separation can be combined and used simultaneously to allow a large number of distinct channels to be used, such as when multiple modulating frequencies f_{M1}, f_{M2} etc. are used.

Moire Beats Appearance

FIG. 8A is an example of the appearance of beats 137 for an input signal 136 S(t) varying in intensity between dark and light. The appearance of the signal is similar to stellar absorption spectra, if the independent variable t is replaced by wavenumber ν. The upper portion of FIG. 8A is S(t) alone, as if measured conventionally. The lower portion of FIG. 8A represents S(t) modulated by a sinusoid, showing how the invention would measure S(t). The phase varies in the vertical direction so that the sinusoid has the appearance of a periodic comb of slanted lines, and multiple output channels 139 A, 140 B and 141 C having different phases are obtained by sampling the signal along the horizontal axis at different vertical positions. Note the bead-like appearance of the Moire pattern 137, which are beats formed through the heterodyning process between the comb 138 frequencies and the frequencies in the signal S(t). The beats are especially easy to see for the section of the signal 142 which have features sharing nearly the same spacing (and hence frequency) as the comb spacing, since then the beat frequency, which is the difference between the comb and signal frequencies, is low, and therefore forms broad patterns easier to detect.

FIG. 8B is an example of the appearance of the beats 134 at the edge of a step function input signal 133 S(t). A step function is typical of signals produced in shockwave research, such as the abrupt change in reflectivity or incandescent light emission from a target being struck by a shockwave. The upper portion of FIG. 8B is S(t) alone, as if measured conventionally. The lower portion of FIG. 8B represents S(t) modulated by a multiphase sinusoid 135, showing how the invention would measure S(t). Note the bead-like appearance of moiré beats 134 at the edge of the step, similar to those 137 of FIG. 8A. (The beats become more apparent when the ordinary shape of the step 133 is subtracted from the signal, highlighting the portion that changes with phase.)

FIG. 8C is an example of the appearance of the beats 132 for an input signal 130 which already has multiphase character. This could be an interferometer output, plotted versus output phase in the vertical direction and time in the horizontal. An example application is a velocity interferometer measuring the abrupt change in velocity of target being hit by a shock wave. The portion of the signal at the time 131 labeled the “edge region” is where the input signal 130 is changing most rapidly, and which is the most difficult to record, since the rate at which the fringes of the input signal 130 pass by can exceed the frequency response of a detector. The upper portion of FIG. 8C shows the input signal measured conventionally (ie. with constant illumination). The lower portion of FIG. 8C shows the input signal modulated by a single phase sinusoid. Multiple phases are provided in this case by the input signal rather than the modulation. The beats 132 are especially apparent in the region 131 where the frequency of the modulation is similar to the input signal.

Spatially Varying Phase

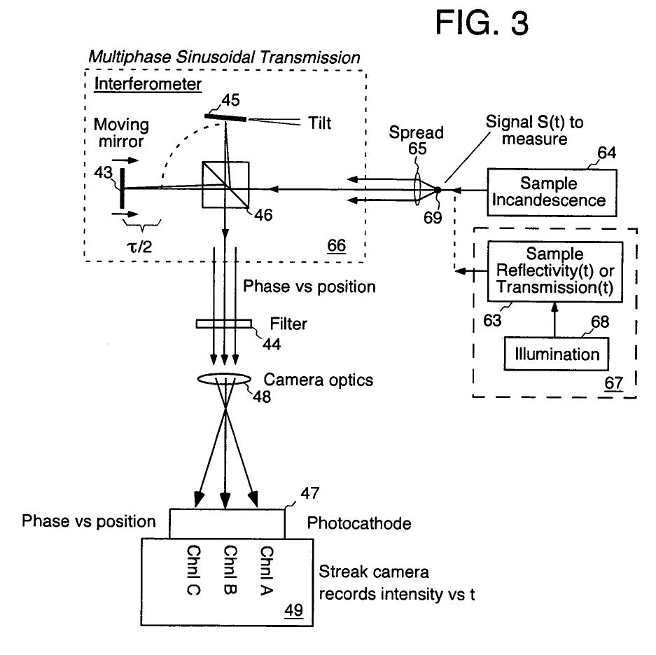

FIG. 3 shows an embodiment of the invention measuring the time varying intensity S(t) of a light source 69 by passing it through a multiphase periodic modulation system 66 that modulates it at frequency f_{M}. The phase is made to vary spatially across the output beam. The light source 69 could be from a sample 64 which emits time dependent incandescence or fluorescence, or an optical fiber emitting communication signals, or it could be light 67 from a sample 63 that has a time varying reflectance or transmission under illumination 68.

The means for producing spatially encoded multiphase sinusoidal transmission is an interferometer 66 with a moving mirror 43, so that the interferometer delay τ (net optical path difference between arms, beamsplitter 46 to mirrors 43 and 45) changes with time at a rate of v=λf_{M}. A narrowband filter 44 can define the dominant wavelength if the source 69 is broadbanded. One of the interferometer mirrors, such as 45, is tilted so that the interferometer delay τ varies versus position across the beam by at least ⅔ of a wavelength λ, so that at least three output channels can be formed having 0, ⅓ and ⅔ cycles of phase. If the light source is pointlike, it can be spread wider by lens 65 to span across the required width (at mirror plane 45) to have the minimal ⅔ cycle phase difference. A camera system 48 images the mirror plane 45 or 43 to the streak camera 49 input photocathode 47 so that the phase varies across the streak camera record. The streak camera 49 is a multichannel intensity versus time recording device.

Alternatively, the sinusoidal transmission system 66 could be implemented by at least three parallel channels of a variable gain electrical amplifier (ie. a gate) modulated by an oscillating signal at frequency f_{M}, and delayed between the channels to produce the needed approximate 0, ⅓ and ⅔ phase shifts, if the light from source 69 was converted prior to the amplifier into an electrical signal.

Part 1: Phase Stepping Analysis

Regular and Irregular Phases Configurations

FIG. 10A shows multiphase sinusoidal illumination versus time, for the particular regular case of three channels 170, 171 and 172 having ⅓ cycle of phase step between them. This could be 22 associated with the embodiment in FIG. 1. This could also be a plot of interferometer 66 transmission versus time associated with FIG. 3. This could also be a plot of interferometer 111 transmission versus wavenumber ν in FIG. 7, if the time variable is replaced by wavenumber. When the phases are regularly spaced about the phase circle and have equal visibility (amplitude of the sinusoidal part), then the sum or average 173 intensity of all the channels is a constant. This is the optimal situation. This is mathematically equivalent to saying that the vector sum of the channels is zero, where each channel is represented by a vector 174, 175, or 176, where the angle of the vector represents the phase and its length represents the visibility. The vector diagram 186 in FIG. 10B shows the configuration for four regular phases of ¼ cycle step, diagram 188 for three regular phases of ⅓ cycle step, and analogous diagrams can be drawn for any number of regular channels.

FIG. 10C shows diagrams for several kinds of irregular channel phase relationships, which are non optimal. Configuration 177 shows irregular phase, where the phase intervals between adjacent channels are not the same value 1/k (in cycles), where k is the number of channels. The vector 179 is deviated from the regular angle indicated by the dashed line 178. Configuration 187 shows irregular visibility (also called magnitude). The length of vector 180 differs from the lengths of the other vectors, indicated by circle 182.

The minor degree of irregularity depicted by 177 and 179 is often encountered in practice. It would cause errors in conventionally methods of phase stepping analysis that assume regular or known phase intervals. Thus it is useful that irregular and unknown phases and visibilities can be tolerated by the invented algorithm described below. It is optimal that the phases be approximately evenly distributed around the circle to avoid the worst-case situation in configuration 182, where all the vectors lie in the same semicircle, or even worse, same quadrant.

The further the phase angles are from their regular values, the worse the signal to noise ratio will become. This is because in the effort to modify configuration 182 into the necessary “balanced configuration” which has a vector sum of zero, two vectors such as 183 B and 184 C will be subtracted from each other (to form a new vector pointing in a more favorable direction, more or less perpendicular to the 3rd vector 185 A). However, subtracting two data that are nearly the same magnitude will produce a small difference but have roughly the same absolute noise, so the signal to noise ratio will dramatically decrease, which is bad.

Minimum Number of Channels

For a wide bandwidth signal, a minimum of three distinct phase channels are needed to separate the beats from its conjugate, and from the ordinary signal component. A “balanced” configuration of pointing vectors needs to be formed, as will be shown, and this requires at least three distinct phases.

Note, the special case of two channels at exactly 180 degrees phase difference is not practical, because although it produces the balanced condition which allows the ordinary signal to be separated from the beats, it does not allow the real valued beats to be converted into the single-sided complex form, because the two pointing vectors point in opposite directions for both the beats and the conjugate beats, so manipulations that cancel the beats also cancel the conjugate.

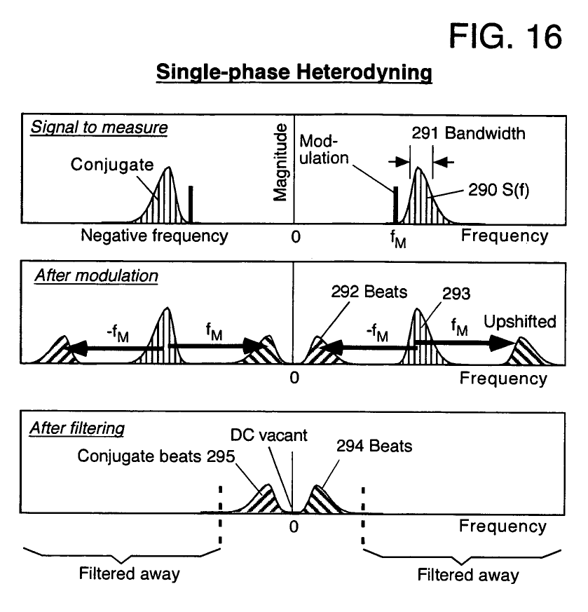

In many conventional applications of heterodyning such as a radio receiver the input signal S(t) 290 is at high frequency relative to its bandwidth 291, so that the beat signal 292 at low frequency is not in danger of being confused with S(t) 293. (See FIG. 16 which shows both the up and down shifting heterodyning that occurs under sinusoidal modulation.) Then the beats and ordinary components from a single channel can be separated by passing the modulated signal through a lowpass filter which attenuates S(t) 293 relative to the beats signal 292. Secondly, f_{M} can be placed to the side of the average frequency of S(t) so that the beats 294 are not centered near zero frequency, so that the beats 294 and its conjugate 295 do not significantly overlap. Then simply deleting negative frequencies isolates the beats from its conjugate. In this case only a single phase channel is needed.

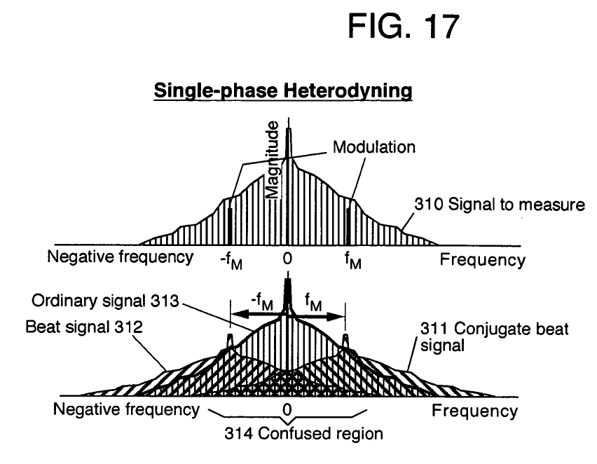

In wide bandwidth signals the beats, its conjugate, and the ordinary components may overlap in frequency so that frequency-filtering is not an optimal method to separate these components. (FIG. 17 shows an example of overlap 314 when a single phase modulation is used on a wide bandwidth signal.) In this case a minimum of three distinct phase channels are needed to separate the components.

Phase Stepping Analysis

The art of taking data having different interferometer phases is “phase stepping” or “phase shifting interferometry”. The art of combining several different channels of data into a single complex channel representing phase and magnitude is called “phase stepping analysis”. The output is complex so that both phase and magnitude are represented by a single value, which is convenient mathematically. It is equivalent to represent the complex value by a vector in the complex plane. In some phase stepping measurements, such as determining the phase of a spatially uniform beam of an interferometer, the data for each phase step is measured just once, so there is no independent variable such as time, spatial position, or wavelength. In contrast, the applications for which the invention is optimized, the goal is to measure the fringe phase and magnitude versus many values of an independent parameter such as time, spatial position or wavelength. Hence the output of our phase stepping analysis is a complex signal or function. The independent variable in this document is usually assumed to be time (t), for concreteness, but in the applications of measuring a spectrum with an interferometer combined with a wavelength dispersive spectrograph, the analogous independent variable is wavelength (λ) or wavenumber (ν=1/λ). In the latter case, the form of complex data versus wavenumber or wavelength has been called a “vector spectrum” in this inventor's patent U.S. Pat. No. 6,351,307. It is appreciated that the phase stepping analysis and other signal processing function discussed herein may be implemented using various data processing devices known in the art, including but not limited to computer software, firmware, integrated circuits, FPGAs, etc.

The phase stepping algorithm presented below is not limited to analyzing heterodyned data but is generally useful for converting one or two dimensional interferograms or real-valued fringing-like data, taken through a set of phase stepped exposures, into a single-sided complex signal output. An example of a two-dimensional interferogram is a hologram, or a measurement of the wavefront error on an optic observed using an interferometer. An example of a one-dimensional “interferogram” is a conventional VISAR Doppler velocity interferometer output versus time. (Usually this apparatus simultaneously outputs four channels at ¼ cycle phase relationship.)

The phase and visibility of a given portion of the interferogram is represented by the complex value of the output signal Wₛₜₑₚ(t), where the independent variable “t” is a placeholder for the actual independent variable, which could be a spatial variable along a 1-dimensional or 2-dimensional image in the case of hologram, or wavelength or wavenumber in the case of a vector spectrum. The notable advantage of this algorithm is that it can handle irregular phase steps that often occur in interferometry due to mechanical vibration or air convection. The algorithm removes the fixed pattern component of the signal which does not vary synchronously with the phase steps, such as the ordinary image or the unwanted pixel to pixel gain variations of the CCD detector. In the description of the phase stepping algorithm the fixed pattern component is represented by the “ordinary” component, the desired fringing portion represented by the “beats”, the phase stepped input data by Iₙ(t), and the output signal by Wₛₜₑₚ(t).

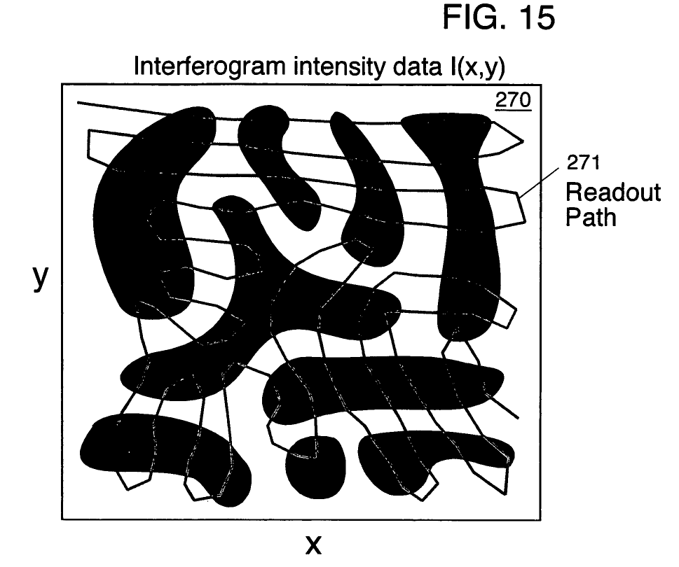

When measuring a two dimensional interferogram 270 (FIG. 15), the independent variable “t” would represent a spatial variable. The two dimensional pattern 270 could be converted to a one dimensional signal I(t), intensity versus “t”, by overlaying the pattern with a readout path 271 selected by the user, and tracing intensity along the path. Provided the same readout path is used for all the phase stepped exposures, the choice of path shape is not critical.

Regarding the heterodyning application, the phase stepping analysis is the first part of the whole data analysis. The second part could be called “reconstruction of the signal” and seeks to numerically reverse the heterodyning that occurs in the instrument, and combine it with the ordinary signal component, to form a more accurate measure of the signal, particularly for high frequencies that normally are beyond the capability of the detector to sense. This part is discussed later.

Phase Stepping for Regular Phase Channels

Let us first describe phase stepping analysis for a regular phase configuration where the phase step Δφ between channels is Δφ=1/k in cycles, where k is the integer number of channels and is at least three, and where the visibility of each channel's modulation is the same, so that the vector configuration is analogous to 188 or 186, but with k number of vectors. Each channel data Iₙ(t) is assumed normalized so that its value averaged over time (and thus insensitive to the oscillatory component) is the same for all channels. The general expression for the complex phase stepped output wave Wₛₜₑₚ is

$${W}_{step} ( t ) = {\sum }_{n} {I}_{n} ( t ) {ⅇ}^{{ⅈ2πθ}_{n}} \qquad Eqn . 1$$

where we choose
θₙ=φₙ Eqn. 2
and where index n is over the k channels (such as detected by items 25 in FIG. 1), and Iₙ(t) is the detected signal of the nth instrument channel. Note that we choose the schedule of “software” rotations θₙ to be synchronous with the “hardware” phase shifts φₙ applied during data taking. For the particular case of four channels, Eqn. 1 and Eqn. 2 reduce to
Wₛₜₑₚ(t)={I₁(t)−I₃(t)}+i{I₂(t)−I₄(t)} Eqn. 3
and for three channels reduces to
Wₛₜₑₚ(t)={2Iₙ(t)−I₂(t)−I₃(t)}+i\sqrt{3}{I₂(t)−I₃(t)} Eqn. 4
Note that Eqn. 3 manifests the familiar four-bucket algorithm, where the real part (I₁−I₃) and imaginary part (I₂−I) would be used as numerator and denominator in a ratio to express the tangent of the phase angle of Wₛₜₑₚ(t), if Wₛₜₑₚ(t) was expressed in polar coordinates.

Equation 1 works because only components which shift synchronously with the applied phase stepping φₙ will be rotated so that they are stationary, and therefore survive the summation to produce a nonzero result. Other components will sum to zero.

Let us given an example. Let S(t) be the signal to be measured, and Tₙ(t) be the modulation for the n^{th} output channel, normalized to an average value of unity.
Tₙ(t)=1+γₙ cos(2πtf_{M}+2πφₙ) Eqn. 5
For a regular configuration the modulation visibilities γₙ are all the same, so for simplicity let us set them to unity, γₙ=1. For simplicity of phase stepping related equations, the detector blurring will be ignored. Then the signal Iₙ(t) detected by the instrument for the nth channel, ignoring detector blurring, will be the product of these two
Iₙ(t)=Tₙ(t)S(t) Eqn. 6
and after substituting Eqn. 5, our model for Iₙ(t) is
Iₙ(t)=S(t)+(0.5)S(t)e^{-i2πtf}^{_{M}}e^{-i2πφ}^{ₙ}+(0.5)S(t)e^{i2πtf}^{_{M}}e^{i2πφ}^{ₙ} Eqn. 7
The first term is the ordinary unheterodyned detected signal (313 of FIG. 17), which because we neglected blurring is the same as the signal to be measured 310. This first term is stationary with respect to the phase stepping φₙ. The second term is the beats 312, which is the signal shifted toward negative frequencies. The third term is the conjugate beats 311, which is the signal shifted toward positive frequencies. The beats and conjugate beats rotate in opposite directions with respect to the instrument phase stepping φₙ. It is arbitrary whether one chooses the positive or negative frequency branch to be the conjugate or nonconjugate, since real functions are symmetric regarding frequency. For concreteness we choose the beats to be the component whose frequencies are made more negative by the heterodyning. This leads to designating the second term to be the beats rather than the third.

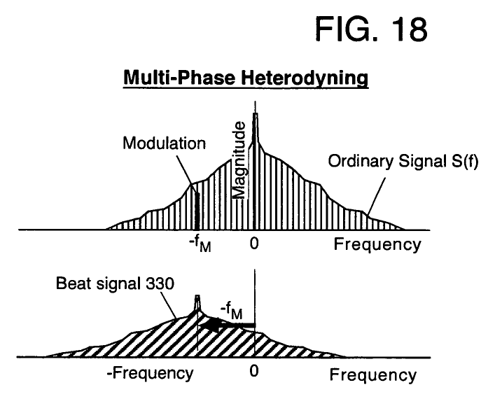

The multiplication of S(t) by the phasor e^{-i2πtf}^{_{M}} causes the single-sided heterodyning we seek. The S(t) can be thought of as a Fourier sum of components e^{i2πtf} having different frequencies f, and multiplication by the phasor will shift each component frequency to (f−f_{M}). We call it single-sided heterodyning (depicted by FIG. 18) when the beats 330 are isolated from the conjugate beats and ordinary unheterodyned signal. If both the beats and conjugate are present, such as in a single channel I_{osc}(t) used in isolation, then both polarities of frequency shift at the same time. This prevents simple reversal of the heterodyning. Secondly, for single phase heterodyning if the signal has a wide bandwidth there can be a confusion between the three components for low frequencies, shown as frequency region 314 in FIG. 17. By first isolating the beat component 330 from both the conjugate beats and from the ordinary component by combining multiple phase channels, then single-sided heterodyning is obtained. Then the heterodyning can be reversed by simply shifting the entire signal Wₛₜₑₚ(t) toward positive frequencies by f_{M}, such as by multiplying it by a phasor e^{+i2πtf}^{_{M}}.

Restating, a single channel Iₙ(t) of the detected instrument output is not sufficient by itself for reversing the heterodyning and recovering many wide bandwidth signals, because frequency overlap (ie. 314) prevents separating the components using filtering. Hence the purpose of combining multiply phased channels Iₙ(t) through a phase stepping analysis, such as Eqn. 1, is to isolate the beat term from its conjugate, and from the ordinary signal, so that it manifests a single-sided heterodyning component 330. Multiple phases are necessary to produce wide bandwidth single-sided heterodyning.

Continuing with the example showing that Eqn. 1 works, we substitute Eqn. 7 into Eqn. 1 to produce

$${W}_{step} ( t ) = S ( t ) {\sum }_{n} {ⅇ}^{{ⅈ2πϕ}_{n}} + ( 0.5 ) S ( t ) {ⅇ}^{- ⅈ2π {tf}_{M}} {\sum }_{n} 1 + ( 0.5 ) S ( t ) {ⅇ}^{ⅈ2π {tf}_{M}} {\sum }_{n} {ⅇ}^{ⅈ2π ( 2 {ϕ}_{n} )} \qquad Eqn . 8$$

The first and last terms sum to zero, leaving only the middle term

$${W}_{step} ( t ) = \frac{k}{2} S ( t ) {ⅇ}^{- ⅈ2π {tf}_{M}} \qquad Eqn . 9$$

which is the isolated beat term, as promised. The first term cancels because

$${\sum }_{n} {ⅇ}^{{ⅈ2πϕ}_{n}} = 0 \qquad Eqn . 10$$

since regular phases are symmetrically positioned around the phase circle. That is, the channel vectors add to zero, which is called a “balanced” vector configuration. Note that the third term

$${\sum }_{n} {ⅇ}^{ⅈ2π ( 2 {ϕ}_{n} )} = 0 \qquad Eqn . 12$$

rotates at 2φₙ instead of φₙ. This term cancels because if φₙ are regularly spaced, then 2φₙ are also regularly spaced.

In addition to needing the beat signal, the ordinary signal S_{ord}(t) is also needed for signal reconstruction. This is easily obtained from regular phase stepped data by summing over all channels without any rotation θₙ,

$${S}_{ord} ( t ) = \frac{1}{k} {\sum }_{n} {I}_{n} ( t ) \qquad Eqn . 13$$

since the symmetrically arranged phases of the beat and conjugate terms will sum to zero.
Phase Stepping for Complex Inputs

The input signals of the phase stepping equation Eqn. 1 can be complex, such as vector spectra from an externally dispersed interferometer taken while being phase stepped. The benefit of using Eqn. 1 and Eqn. 2 on vector spectra is to eliminate systematic errors such as the fixed pattern error associated with pixel to pixel gain variations of a CCD detector. Such errors do not vary synchronously with φₙ and hence are canceled by a rotation schedule θₙ=φₙ, just like the ordinary component.

Dot Product Definition

Complex signals can be treated as vector quantities in the two dimensional (real and imaginary axes) complex plane. One of the more useful operations to perform on them, besides addition, subtraction etc., is finding the dot product between two complex signals. This operation indicates how similar two signals are, and when used with a reference signal and its perpendicular, can be used to find the phase angle that characterizes the signal. It is also used to find the degree of crosstalk between two signals.

The dot product between two signals A(t) and B(t) is the integral over time (from Tₛₜₐᵣₜ to T_{end}) of the instantaneous dot product A*B

$$A ( t ) \cdot B ( t ) ≡ {\int }_{Tstart}^{Tend} ⅆ t \{ Re A ( t ) \} \{ Re B ( t ) \} + \{ Im A ( t ) \} \{ Im B ( t ) \} \qquad Eqn . 14$$

The “Re” and “Im” symbols represent taking the real and imaginary parts. It is also useful to define a perpendicular to a signal B(t), called B_{⊥}(t) as
B_{⊥}(t)≡−iB(t) Eqn. 15
since rotating something 90 degrees in the complex plane is equivalent to multiplying it by i or −i, so that B_{⊥}(t)·B(t)=0. (How one defines positive angles is usually arbitrary.)
Phase Stepping for Irregular Configurations

In many applications the channel phases φₙ can be irregularly positioned around the phase circle (as in configuration 177), not being multiples of 1/k, or the visibilities may not be all the same (as in configuration 187). Secondly, the phases φₙ and visibilities γₙ may be initially unknown as well as irregular. Then the simple algorithm Eqn. 1 and Eqn. 2, will most likely fail to completely cancel both the ordinary and conjugate beat components. This is because

$${\sum }_{n} {γ}_{n} {ⅇ}^{{ⅈ2πϕ}_{n}}$$

for an irregular phase configuration is probably nonzero. Secondly, even if this sum happens to cancel, the third term

$${\sum }_{n} {γ}_{n} {ⅇ}^{- ⅈ2π ( 2 {ϕ}_{n} )}$$

having twice the phases is unlikely to simultaneously cancel.

The algorithm presented below, called “Irregular Step” algorithm, successfully isolates the beat component from the conjugate beat and ordinary component to form a single-sided heterodyning signal, and forms the isolated ordinary signal, in spite of having irregular channel phases and visibilities. Furthermore, it can do this when the detailed value of the phases and visibilities are initially unknown, which is very useful practically. And naturally, it also works for the regular configurations.

The algorithm is broken into two stages: I. Isolate the effective ordinary component to be used in later signal reconstruction. Subtract it from each channel's data to produce a set of oscillatory signals, where each is the sum of beats plus conjugate beats; II. Combine all the channel oscillatory signals to remove the conjugate beats to produce a single output signal that is purely beats.

Stage I: Isolating Ordinary from Oscillatory

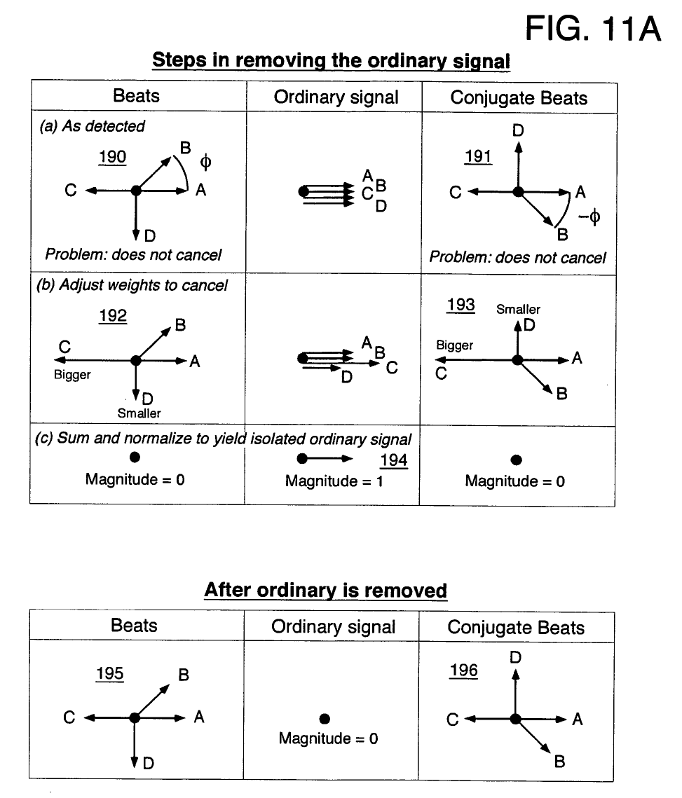

FIG. 11 diagrams the steps in isolating the ordinary component from the set of phase stepped channels Iₙ(t) by forcing vector cancellation of the oscillatory components, which are the beat and conjugate beat terms. The vectors 190 in FIG. 11, 177 or 187 in FIG. 10B, and in other Figures, called pointing vectors Pₙ, represent the visibility and phase of each channel relative to the others
\vec{P}ₙ=γₙe^{-i2πφ}^{ₙ} Eqn. 16
The vector sum of the pointing vectors, also called the residual vector R, is the weighted sum

$${R}^{->} = {\sum }_{n} {H}_{n} {{P}^{->}}_{n} \qquad Eqn . 17$$

where Hₙ are weights which will be discussed below. The channels are said to be “balanced” when R=0.

The pointing vectors are labeled in FIG. 11 and other Figures by A, B, C, D etc. to designate the individual channels. The specific case of four irregular channels is shown at 190. Vector B is shown spoiling the regular ¼ cycle alignment. Because of this, the configuration is not “balanced”.

Each channel's data Iₙ(t) can be expressed as a sum of ordinary, beat, and conjugate beat (if present) components
Iₙ(t)=S_{ord}(t)+\vec{P}ₙS_{beat}(t)+{\vec{P}ₙS_{beat}(t)}* Eqn. 18
The asterisk represents the complex conjugate. If Iₙ(t) is purely real, then the conjugate beats, since they reside on the opposite frequency branch, have the same magnitude as the normal beats but a pointing vector configuration that is mirror reversed regarding the instrument phase steps φₙ. Thus φ for the beats 190 manifests as −φ for the conjugate 191.

However, this reflection property is not the case for any rotational shift θₙ applied mathematically during data analysis, such as with a phasor e^{i2πθ}^{ₙ}. This θₙ affects both frequency branches with the same polarity, and hence rotates both the beat and conjugate diagrams in the same direction. (We use this later to our advantage.) Hence we use two different symbols, φ and θ to distinguish these two different kinds of behavior, hardware phase steps versus software rotations, respectively. (The φ comes from a shift in time axis, of the modulation prior to joining the ordinary signal. Then during phase stepping data analysis, we do not shift the time axis because the ordinary component is assumed already aligned with itself for all the channels, so we apply phasor rotations θ, and these are not the same as shifting the time axis.)

The steps are: Step 1. Normalize each channel data Iₙ(t) so that its value averaged over time (and thus insensitive to the oscillatory component) is the same for all channels.

Step 2. Find the weightings Hₙ which produce a zero sum R of pointing vectors, while holding the average Hₙ constant. This will produce the balanced condition and eliminate the beats 192 (and the conjugate beats 193 if present).

If the pointing vectors are unknown (or known), this can be done with the “best centroid” algorithm described below. If the pointing vectors are known, then Eqn. 17 for R can be evaluated directly and Hₙ chosen by inspection and simple algebra if needed. Note that only two degrees of freedom are needed so there will be redundant solutions if k>3, and any will work. One can gang several Hₙ together so that they scale by the same amount to reduce the original number of degrees of freedom to two.

The reason for using adjustable weightings instead of adjustable rotations θn at this stage is that weightings affect the beat and conjugate equally and can thus achieve cancellation for both simultaneously. Whereas rotations θn would affect the beats and conjugates differently for the irregular configuration (because θn are not mirror reversed for the conjugate).

Step 3. Using these Hₙ, produce a weighted average S_{Wavg}(t)

$${S}_{Wavg} ( t ) = \frac{{\sum }_{n} {H}_{n} {I}_{n} ( t )}{{\sum }_{n} {H}_{n}} \qquad Eqn . 19$$

which will represent the ordinary signal S_{ord}(t) by itself 194. However, this determined ordinary signal, which is used in signal reconstruction to be described later, is represented as S_{ord,det}(t) in order to distinguish it from the previously unknown ordinary signal S_{ord}(t).

Step 4. Subtract this S_{ord,det}(t) from each channel's data Iₙ(t) to form a set of oscillatory-only channel data I_{n,osc}(t)=Iₙ(t)−S_{ord,det}(t). If Iₙ(t) is purely real, the I_{n,osc}(t) consists of both the beats 195 and its conjugate 196 without the ordinary.

The steps 1 through 4 can also be applied to complex channel data, such as vector spectra. In that case each I_{osc}(t) could already be single-sided complex and the following stage II of processing to remove the conjugate beats unnecessary.

Best Centroid Algorithm

This section describes a “best centroid algorithm”, which is a method to achieve the balanced condition by minimizing the variance in the weighted average of all the channels, by adjusting channel weights Hₙ. It is useful because it does not require knowledge of the channel phases or visibilities, works for irregular or regular configurations, any number of channels, and real or complex channel data.

An analogy is a thrown Frisbee, having several weights on its periphery. Each weight corresponds to a channel, and the weight's fractional distance from the center of the Frisbee corresponds to the channel visibility γₙ, and its angular position corresponds to the channel phase φₙ. These positions are equivalently represented by the pointing vector Pₙ. The mass of each Frisbee weight corresponds to a factor Hₙ.

The path of the n^{th} weight through space corresponds to Iₙ(t), (if we allow the Frisbee diameter to change with time). The path of the center of gravity of the Frisbee corresponds to the weighted average S_{Wavg}(t) of all the channels. This is also called a centroid, hence the algorithm name. If the channels are unbalanced, then the Frisbee will wobble when it is thrown while it spins and moves forward. This wobble is in addition to whatever erratic motion the centroid of the Frisbee makes even in the balanced condition (such as due to gusts of wind). The goal is to pick the weights Hₙ to minimize the wobble. A minimum wobble indicates the balanced condition, which is when R=0 (Eqn. 17).

FIG. 12 diagrams a hypothetical path of S_{Wavg}(t), for the cases of an unbalanced condition 210 (solid curve), and balanced condition 211 (dashed curve). The balanced condition has less wobble in the centroid path. The path is shown in the complex plane, as if the input data Iₙ(t) were complex, since that is the most general case. If Iₙ(t) are purely real, then the paths 210 and 211 would only move along the real axis (horizontal). (It is okay to subtract constants, such as time-averaged values of Iₙ(t), from each Iₙ(t) without affecting the location of the minimum of var calculated below in Eqn. 20.)

The balanced condition is found by minimizing the total “variance” in S_{Wavg}(t), which is the self dot product

$$var = {S}_{Wavg} ( t ) \cdot {S}_{Wavg} ( t ) ∝ {\int }_{Tstart}^{Tend} {\vert {\sum }_{n} {H}_{n} {I}_{n} ( t ) \vert}^{2} ⅆ t \qquad Eqn . 20$$

while varying Hₙ and while holding average Hₙ constant. This finds the weights Hₙ which produce the minimum wobble in the centroid path. The key advantage is that the var can be calculated without knowledge of the phases or visibilities of the channels. This least squares process differs from others in that what is being minimized is not the distance between data and a theoretical model for the data (ie. the periphery of an imaginary wheel and the road.) Instead, weighted data is compared against other weighted data. The relevant visualization is that Eqn. 20 deals with finding the best center of a wheel, rather than dealing with the periphery of the wheel and whether or not it is perfectly round.

The accuracy of the method is best when the shapes of the ordinary and beat signals are very different, so that the magnitude of their dot product |S_{ord}(t)·S_{beat}(t)|, called the crosstalk, is very small. Suppose the crosstalk is zero. Then the total variance is sum of contributions from the ordinary and beat components. Since the ordinary contribution is constant (because average Hₙ is held constant), then minimizing the total variance implies that the beat variance is also minimized, which implies R=0, which is the balanced condition.

The crosstalk between A(t) and B(t) could be defined as the fractional magnitude of the dot product between them or its perpendicular B_{⊥}(t),

$$crosstalk = \frac{\vert A ( t ) \cdot B ( t ) \vert + \vert A ( t ) \cdot {B}_{⊥} ( t ) \vert}{\vert A ( t ) \vert \vert B \vert} \qquad Eqn . 21$$

so that a similarity in shape will be detected no matter what the phase angle between A(t) and B(t). The crosstalk was normalized by the intrinsic size of each signal by itself.

In other words, the path of the centroid should be different from the path of the wobble, otherwise their confusion creates an error in Hₙ which grows with the size of the crosstalk. This error creates unexpected “leakage” of the ordinary component in with the beat component. During heterodyning reversal this adds a false signal, which is the leaked ordinary component shifted up to higher frequency by interval f_{M}.

The crosstalk generally becomes smaller for a larger time interval, Tₛₜₐᵣₜ to T_{end}, over which the variance is calculated. Conversely, the best centroid variance method cannot work for a single instance in the time variable—it requires a range of time values, so that the beat and ordinary signals can manifest different shapes.

Since the phase relationships between the channels is usually constant, then if one has at least approximate knowledge of the shape of S_{ord}(t) and S_{beat}(t), one can calculate how the crosstalk varies for different choice of Tₛₜₐᵣₜ and T_{end}, and choose times that minimize the crosstalk. Then after Hₙ are found, apply these Hₙ to the entire data time range. This knowledge could come from applying the data analysis procedure iteratively. Secondly, the estimated crosstalk terms S_{ord}·S_{beat} and S_{ord}·S_{beat} can be included explicitly into the calculation of the variance Eqn. 20, instead of being an unknown additive. This can reduce the crosstalk error to insignificance. This-requires only approximate knowledge of the channel phases, which is easily obtained by applying the phase stepping analysis iteratively (to obtain I_{osc}(t)) and using Eqn. 22 below.

In summary, the problem of crosstalk can be made insignificant compared to the great practical advantages of not requiring prior knowledge of the channel phases or visibilities, and not requiring them to be regular.

Finding Channel Phase Angles

A signal's phase angle φₙ and visibility γₙ can be found if its beat component is isolated, by taking dot products with a designated reference signal Q(t). This allows one to calculate approximate phase angles and visibilities for each channel from I_{osc}(t), which is useful in selecting Hₙ such as when applying the phase stepping analysis in an iterative fashion. Or if the conjugate beat and ordinary components have already been largely removed, such as with vector spectra, or signals after stage II. The reference signal could be the estimated beat component itself, used iteratively.

A channel's oscillatory signal I_{osc}(t) contains both beat and conjugate components, since it is real valued, but we need the reference signal to have zero or small dot-product (i.e. crosstalk) with the conjugate so that it only senses the beat component. This can be accomplished several ways. First, the reference signal Q(t) can be chosen to be the current best estimate of the beat signal. The beat and conjugate naturally have small crosstalk because the real parts correlate while the imaginary parts anti-correlate, so their sum tends stochastically toward zero if the time duration is long. Secondly, one can filter the reference wave so that it is only sensitive to a frequency band known to contain mostly the beat component, and thereby be insensitive to the conjugate. For example, one can restrict the reference to very negative frequencies, or the narrow frequency band around −f_{M} which can manifest a large signal magnitude if detector blurring is not severe.

Thirdly, one can pick time boundaries Tₛₜₐᵣₜ and T_{end} that minimize the crosstalk if one has knowledge of the isolated beat and conjugate beat components. Such knowledge comes through iterative application of stage II, described below. Knowledge of the estimated isolated beats yields knowledge of its complex conjugate. Then these can be used in a dot product calculation to pick better time boundaries that minimize the crosstalk and thus improve the calculation of the phase angles and visibilities, which in turn improves the recalculation of the beats, etc. iteratively.

The pointing vector for a channel is found through
\vec{P}ₙ={I_{n,osc}(t)·Q(t)}+i{I_{n,osc}(t)·Q_{⊥}(t)} Eqn. 22
where the channel number subscript “n” has been omitted for clarity, and where Q(t) is a normalized reference signal, so that Q(t)·Q(t)=1, and Q(t)·Q_{⊥}(t)=0. The phase φ and visibility γ of the pointing vector is thus
tan φₙ={I_{n,osc}(t)·Q_{⊥}(t)}/{I_{n,osc}(t)·Q(t)} Eqn. 23
γₙ²={I_{n,osc}(t)·Q_{⊥}(t)}²+{I_{n,osc}(t)·Q(t)}² Eqn. 24
How to Find Weights

There are at least two methods of finding the sets of weights which minimize the variance Eqn. 20: an interactive method, and an analytical method.

In the iterative method, one tests every channel to identify which Hₙ has the strongest magnitude of effect on the variance. Let us call that channel m. Then one moves that Hₘ by an amount ΔH to the position that minimizes the variance, while moving all the other Hₙ in the other direction by a smaller amount ΔH/(k−1), so that the average Hₙ for all k channels is unchanged. Then one repeats the process until the variance no longer decreases significantly.

In the analytical method one reduces the number of degrees of freedom to two by ganging several channels together so that they move in a fixed ratio. For an example of four irregular phases that are spaced roughly every ¼ cycle, we transform the four original channel data of I₁, I₂, I₃, and I₄ into four new signals based on the approximate center of mass reference frame
I_{diffX}=(I₁−I₃)/2 & I_{diffY}=(I₂−I₄)/2 Eqn. 25
I_{sumX}=(I₁+I₃)/2 & I_{sumY}=(I₂+I₄)/2 Eqn. 26
with new weights associated with each I-function. We keep the weights H_{sumX} and H_{sumY} constant (set at unity) so that the total ordinary component is constant, while we change the weights H_{diffX} and H_{diffY} that scale the size of I_{diffX} and I_{diffY} to minimize the variance. The time parameter “(t)” has been omitted for clarity from the I-signals. The variance Eqn. 20 is re-written to be a function of these two new weights. One can use the tranformation back to the original reference frame
I₁=I_{sumX}+H_{diffX}I_{diffX} & I₃=I_{sumX}−H_{diffX}I_{diffX} Eqn. 27
I₂=I_{sumY}+H_{diffY}I_{diffY} & I₄=I_{sumY}−H_{diffY}I_{diffY} Eqn. 28
to aid in writing the variance expression, which will be a function of just the two weights H_{diffX} and H_{diffY}, a 2-dimensional surface having a minimum which is a paraboloid. The location of this minimum can be found analytically by writing expressions for the partial derivatives of the surface in the two variables, setting the derivatives to zero, and solving the resulting equations.
Stage II: Canceling Conjugate Beats

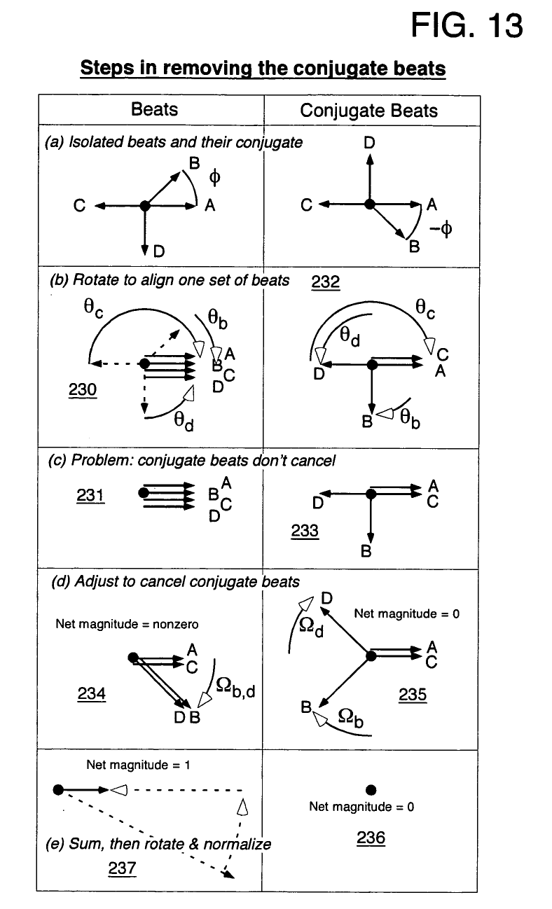

At this point the ordinary component has been removed from each channel data Iₙ(t) to form a set of channel oscillatory signals I_{n,osc}(t). In this next stage (II), the set of I_{n,osc}(t) are combined to form a single output Wₛₜₑₚ(t) in such a way to have a cancelled (balanced) conjugate term, and thus form an isolated single-sided beat signal (similar to Eqn. 9) ready for heterodyning reversal (which is done in stage III). If the channel data Iₙ(t) began as complex data such as vector spectra, then the conjugate term may already be absent, and so this stage II can be skipped. However, it still could be used for combining the k phase stepped channels of data together in a coherent manner so that they do not phase cancel, but instead add constructively, so that they form single output that has less noise because of averaging. FIG. 13 shows the steps in canceling the conjugate beats, which are assumed to be in an irregular configuration.

Step 1

Step 1. A preparatory step is to find the channel phase angles φₙ and visibilities γₙ using Eqn. 22 (or equivalently Eqn. 23 and Eqn. 24), using a reference wave Q that should have minimal or no crosstalk with the conjugate component. As already discussed, these angles can be more accurately calculated after iterative application of stage II, because knowledge of the isolated beats yields a better reference wave having smaller crosstalk with the conjugate, which in turn yields a more accurate knowledge of the beats.

Step 2

Step 2. the channel data I_{n,osc}(t) are rotated 230 by applying phasors e^{i2πθ}^{ₙ}, using angles θₙ=−φₙ, chosen to bring the beat pointing vectors Pₙ into alignment 231 so that they point in the same direction, such as zero angle. Remember that because these rotations θₙ are applied during data analysis, not with the instrument hardware as with φₙ, both the beat 230 and conjugate 232 are rotated with the same polarity. Because the θₙ are irregularly positioned, or have irregular visibilities γₙ, this will usually result in an unbalanced condition for the conjugate 233.

Step 3. Using rotations or changing weights applied to I_{osc}, or both, the conjugate beats are brought into a balanced configuration (cancellation) which simultaneously produces for the beats term a strongly unbalanced configuration (i.e. constructive vector addition). There may be multiple solutions, and the solution that produces the largest unbalanced beat term is optimal. Let us give separate examples for the rotational method (step 3a) and the weight method (step 3b).

Step 3a

Step 3a. A set of rotations Ωₙ are applied to I_{n,osc}(t). The angles are chosen to produce a balanced condition 235 for the conjugate while simultaneously producing a strongly unbalanced configuration 234 for the beats. Since the angles of the conjugate after step 2 will be −2φₙ, the equation for producing a balanced conjugate is

$${R}_{cnj} = {\sum }_{n} {γ}_{n} {ⅇ}^{- {ⅈ2πΩ}_{n}} {ⅇ}^{ⅈ2π ( 2 {ϕ}_{n} )} = 0 \qquad Eqn . 29$$

where R_{cnj} is called the conjugate residual. Since the angles of the beat after step 2 will all be zero, the equation for producing an unbalanced beats term is

$${\sum }_{n} {γ}_{n} {ⅇ}^{- {ⅈ2πΩ}_{n}} \neq 0 \qquad Eqn . 30$$

We desire to simultaneously satisfy both Eqn. 29 and Eqn. 30. One can use Eqn. 22 to find φₙ and γₙ for this. (Alternatively, one can use step 3b instead of step 3a because it does not require knowledge of φₙ or γₙ.)

The channels which are most influential to rotate are those that are (after step 2) most perpendicular to the conjugate residual R_{cnj}. Thus one computes R_{cnj} with Eqn. 29, forms its perpendicular by R_{⊥cnj}=−iR_{cnj}, and takes dot products between R_{⊥cnj} and each pointing vector. The channels which have large magnitude of dot product are the best candidates for rotation. Some or all are rotated until the magnitude of the freshly recomputed R_{cnj} is minimized. Then the process of identifying the most influential channels and rotating them is repeated iteratively, until R_{cnj} becomes insignificantly small.

Now we have the sum of all the so-rotated channel data yielding a cancelled conjugate 236 with an uncancelled beat term 237,

$${W}_{step} ( t ) = {\sum }_{n} {I}_{n , osc} ( t ) {ⅇ}^{- {ⅈ2πΩ}_{n}} {ⅇ}^{- {ⅈ2πθ}_{n}} \qquad Eqn . 31$$

which is our phase stepped output Wₛₜₑₚ(t). Note that it is not necessary that all the beat terms align perfectly, because if the angles between the various beat pointing vectors are not more than, say 45 degrees apart, the diminution of the sum vector is not significant. The Wₛₜₑₚ(t) 237 may therefore point at some arbitrary angle, which is okay, since Wₛₜₑₚ can be rotated and normalized in the next step 4.
Step 3b

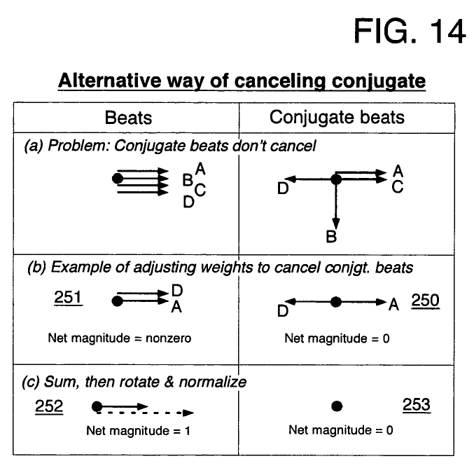

Step 3b can be used instead of step 3a. It has the advantage of not requiring knowledge of φₙ and γₙ, but the disadvantage of possibly producing larger output noise because some channel weights may need to be reduced to near zero to achieve balancing. (The signal to noise ratio will be largest when all channels have equal weighting, so that they all can contribute to the average and stochastic variations lessen.) Step 3b is illustrated in FIG. 14.

The conjugate beats are forced into the balanced condition 250 using the best centroid method adjusting weights Hₙ, with the intention that the beats remain in an unbalanced condition 251. The method is the same best centroid method as described above except that the variance must only be sensitive to the conjugate beats and not the beats, instead of being sensitive to both as Eqn. 20 is written. This can be accomplished by temporarily filtering I_{n,osc}(t) to a band of frequencies where it is known that the conjugate is much stronger than the beats, such as for very positive frequencies. Alternatively, instead of minimizing the variance of the data I_{n,osc}(t), one can minimize the sum of pointing vectors that represent the isolated beats, by minimizing the magnitude of the residual R computed in Eqn. 17, where the reference signal Q(t) used to compute Pₙ through Eqn. 22 is optimally sensitive only to the beats and not to the conjugate beats, as already discussed. For example, Q(t) could be the current best estimate of the isolated beat signal, with modified values for the time boundaries and filtered for a modified range of allowed frequencies.

Now we have the sum of all the so-rotated and so-weighted channel data yielding a cancelled conjugate 253 with an uncancelled beats term 252,

$${W}_{step} ( t ) = {\sum }_{n} {H}_{n} {I}_{n , osc} ( t ) {ⅇ}^{- ⅈ 2 {πθ}_{n}} \qquad Eqn . 32$$

which is our phase stepped output Wₛₜₑₚ(t).
Step 4

The next step after step 3a or step 3b, which is optional, is to rotate and normalize Wₛₜₑₚ(t) so it is aligned with and has the same magnitude as some designated reference signal, which could be the Q(t) used to determine phase angles.

Part 2: Signal Reconstruction

Heterodyning in the Hardware

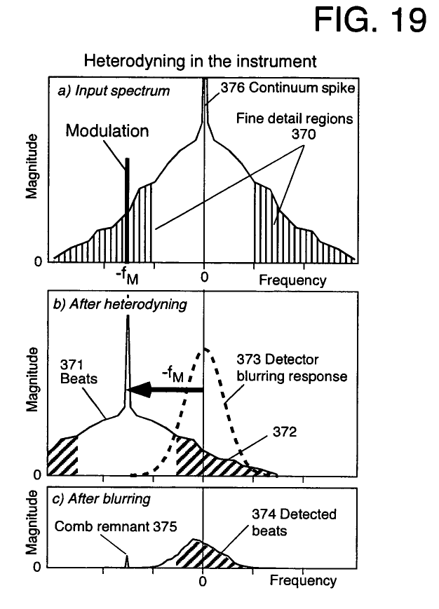

FIG. 19 illustrates the heterodyning process that occurs in the instrument. Hatched areas 370 are the high frequency portion of a signal's spectrum S(f) that are responsible for fine details in S(t). Under multiphase modulation at frequency f_{M} (shown as a −f_{M} to be suggestive of a down shifting) the original signal spectrum S(f) is halved in amplitude, multiplied by visibility γ, and shifted toward negative frequencies by amount f_{M} to form the beats spectrum 371 S(f+f_{M}). (The argument is (f+f_{M}) instead of (f−f_{M}) so that a small f acts as a larger frequency did in the original spectrum.)

Detector blurring eliminates high frequencies so that only low frequencies are detected. This blurring is modeled by multiplying the beats spectrum 371 by a detector frequency response 373 D(f), to form a detected beats signal 374. The D(f) is often modeled as a Gaussian function for mathematical convenience but can better represent the actual response through calibration measurements. The half width at half max (HWHM) of D(f) is called the detector frequency limit and denoted Δf_{D}. This is related to the detector response time T_{D} through the uncertainty principle approximately as (T_{D})(2Δf_{D})˜1.

Note that one of the hatched regions 372 of the beats is located around zero frequencies because of the heterodyning, and thus is much more strongly detected than without the heterodyning. Meanwhile, the ordinary signal is simultaneously being detected (but not shown in FIG. 19), and the original spectrum multiplied against D(f) forms the detected ordinary signal. These two components are separated by the phase stepping analysis described above.

If the detector frequency limit is not too much smaller than f_{M}, some sinusoidal modulation will be seen in the data as a ripple or “comb”. This manifests in the spectrum as a small comb remnant spike 375, which is a greatly attenuated and frequency shifted version of the continuum spike 376, originally at zero frequency. The comb remnant spike indicates −f_{M} in the actual data (useful for the heterodyning reversal discussed below). If the detector blurring is so great that the comb remnant is unresolvable from noise, then f_{M} can be determined through a calibration measurement.

Heterodyne Reversal During Analysis

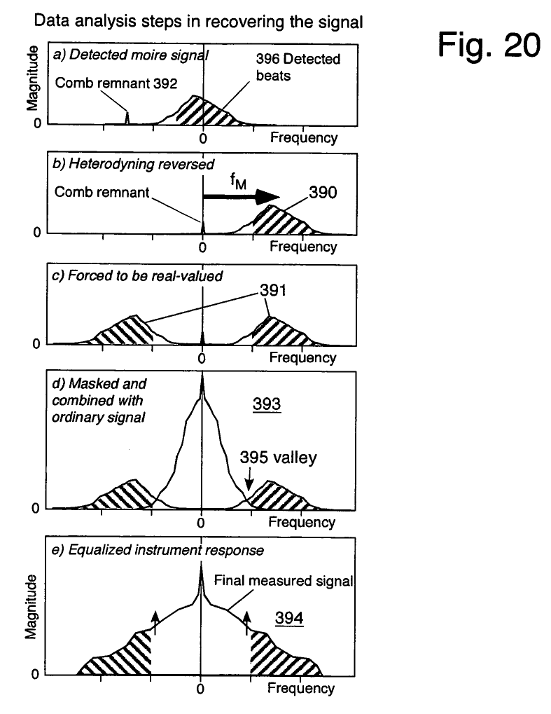

FIG. 20 illustrates the main data analysis steps in reconstructing the original signal from the phase stepped data, using both beats Wₛₜₑₚ(t) and ordinary S_{ord}(t), to create an output S_{fin}(t) having an effective resolution which can exceed that of the ordinary signal used alone.

Step 1, PREPARATION. Prepare the data by removing warp and rebinning the data (discussed later).

Step 2, HET-REVERSAL. Reverse the heterodyning in Wₛₜₑₚ(t) to produce a single-sided treble spectrum 390. This is done by 2a. taking the Fourier transform of Wₛₜₑₚ(t) to form 396 Wₛₜₑₚ(f), 2b. translating the spectrum in frequency space by f_{M} toward higher frequencies to form the treble spectrum 390 W_{treb}(f)=Wₛₜₑₚ(f−f_{M}). The value of −f_{M} is provided by the comb remnant,393 if available, otherwise from a calibration measurement. The label “treble” comes from the analogy to the bass, treble, and tweeter etc. loudspeaker components of a sound signal. The ordinary signal could be called the “bass”.

Step 3, ROTATE TREBLE INTO ALIGNMENT. The W_{treb} is rotated in phase so that it is in proper alignment with the other components, such as the ordinary component, and treble components from other modulation frequencies if they are used. This adjustment is necessary if the value of f_{M} used in the heterodyning reversal step 2 is slightly different than the actual f_{M} in the instrument. The amount of phase rotation can be determined from a calibration measurement of a known signal that is performed by the instrument either at the same time on other recording channels, or soon after the main measurement before the instrument characteristics have time to change.

Step 4, CLEAN OTHER BRANCH. Delete the comb spike now at zero frequency and everything else at negative frequencies (which is mostly noise).

Step 5, MAKE REAL. Produce the double-sided treble spectrum 391 S_{dbl}(f by copying the complex conjugate of W_{treb}(f) to the negative frequency branch (while flipping the frequencies) so that a real valued signal S_{dbl}(t) is formed. This is easily accomplished by taking inverse Fourier transform of W_{treb}(f), setting the imaginary part to zero, and then Fourier transforming it back to frequency space.

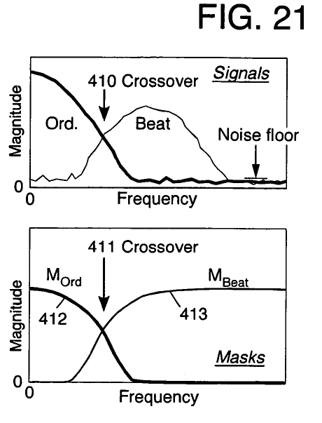

Step 6, MASK AWAY NOISE. The low frequency areas of S_{dbl}(f), where its signal is expected to be small relative to the ordinary detected spectrum S_{ord}(f), are masked away to delete noise, to form a masked spectrum. Similarly, the high frequency areas of S_{ord}(f), are masked away to delete noise in frequency regions where its signal is expected to be small and noisy. (The S_{ord}(f) is the Fourier transform of S_{ord}(t).) Masking is accomplished by multiplication by user defined functions 412 M_{ord}(f) and 413 M_{beat}(f). Examples of these are shown in FIG. 21.

Step 7, ADD BASS & TREBLE. The masked S_{ord} and masked S_{dbl} components are added together to form an unequalized composite spectrum Sᵤₙ(f) 393.

Step 8, EQUALIZE. The Sᵤₙ(f) is equalized by multiplying it by an equalization shape E(f), to form an equalized composite spectrum S_{fin}(f) 394. The E(f) magnifies the spectrum for frequencies in the valley region 395 in between the shoulder of the ordinary spectrum and f_{M} where it is known to be too weak compared to an ideal measured spectrum.

Step 9, TRANSFORM TO TIME-SPACE. Inverse Fourier transform the equalized spectrum to form the final signal S_{fin}(t). This is our measurement for the intrinsic signal S₀(t).

Preparation

In the preparatory step 1, the data may need to be resampled or rebinned to have a greater number of time points, so that the Nyquist frequency is greater than the highest modulation frequency plus Δf_{D}. This makes room for translating the spectrum toward positive frequencies in step 2. The rebinning is easily accomplished by Fourier transforming the data into frequency-space, padding the right (higher frequencies) with zeros so that the maximum frequency on the right, called the Nyquist frequency, is increased, then inverse Fourier transforming back to time-space.

Also in preparatory step 1, the data may need to be de-warped, which is where any nonlinearities in the time axis are removed, if present, so that the modulation is perfectly sinusoidal with constant frequency across all time.

Masking

In step 6 masking was performed to delete data in frequency regions where the signal is expected to be small and noisy compared to the other component. FIG. 21 shows hypothetical masks 412 M_{ord}(f) and 413 M_{beat}(f), and hypothetical expected signal levels for the beats and ordinary components. In the crossover region 410 where the two components have about the same expected signal levels, the optimal shape of the masks is the shape of the expected signals themselves. Hence we make the crossover 411 in masks have a similar shape as the crossover in expected signal strengths 410. Elsewhere, where one component dominates, the choice of mask level is less important, with it better to err on the side of having a smaller or zero mask for the noisy subordinate data component.

Equalization

The goal of equalization is to remove the “lumps” in the raw instrument frequency response L_{raw}(f), to make it a smoothly varying curve L_{goal}(f) that gradually goes to zero at high f. Optimally L_{goal}(f) is a Gaussian function centered at zero f, so that the instrument lineshape in time-space, which is the Fourier transform of L_{goal}(f), has minimal ringing. The equalization shape E(f) is the ratio E(f)=L_{goal}(f)/L_{raw}(f), except for the toe region 430 where E(f) is not allowed to grow to infinity but is limited to unity or a small number. An instrument response L(f) is the smoothed ratio between the measured spectrum and the true spectrum. The L_{raw}(f) can be determined through calibration measurements on a known signal, and depends on γ, D(f), f_{M}, and masking functions M_{ord}(f) and M_{beat}(f).

Note that since both the signal and the noise embedded with the signal is multiplied by E(f), so we are not cheating mother Nature. The signal to noise ratio local to a given frequency f is not altered by equalization. However, the root mean square (RMS) noise averaged over all frequencies and relative to the continuum level is altered, and the coloration of the noise is altered, because some frequency bands will have more noise than others.

Frequency Response

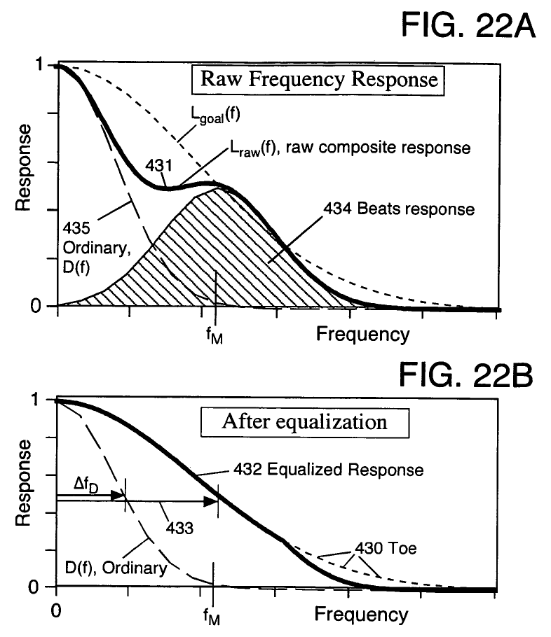

FIG. 22A shows the unequalized frequency response being a sum of the beats and ordinary responses. The use of the beats greatly extends the high frequency response. The beats response 434 has the same shape as the ordinary response 435 D(f) but reduced in height by 2γ and shifted to higher frequency by f_{M}. The user selects f_{M} to position the beats response most favorably for the measurement. Usually the optimal position is on the shoulder of the ordinary response. The valley 431 formed in the composite response can be removed during the equalization step 8, so that the effective lineshape of the instrument using heterodyning is a smooth curve 432 shown in FIG. 22B. This has HWHM bandwidth 433 which is about 2.4 times wider than Δf_{D}, depending on choice of L_{goal}(f). The frequency response has been increased over the detector used without heterodyning. Hence, the time resolution, which is inversely related to the bandwidth, has decreased (improved) by about 2.4 times.

Noise Suppression

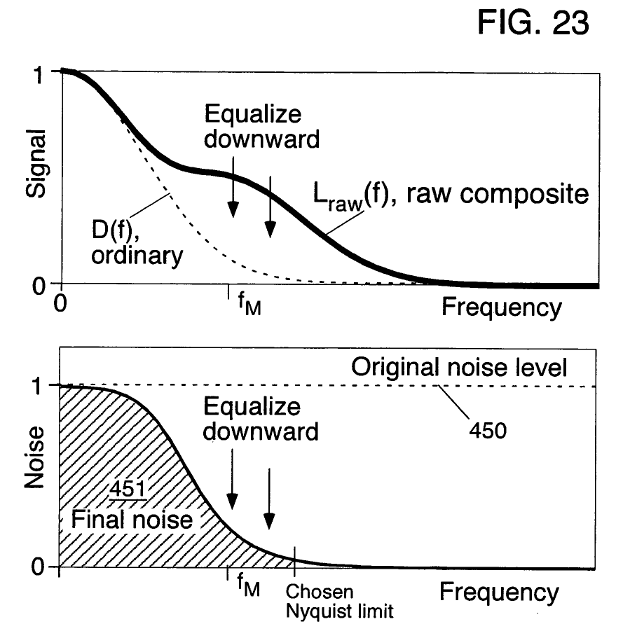

FIG. 23 shows how the RMS noise can be reduced by choosing a different equalization function E(f) which suppresses high frequency parts of the composite signal, and which causes the effective frequency response of the instrument to be the same as the ordinary response D(f), i.e. not increased. The benefit is that the equalization now suppresses high frequency noise 450 that contributes to the RMS total noise, so that net RMS noise (hatched area 451) is smaller. The E(f) is found by setting L_{goal}(f) to D(f), and then E(f)=L_{goal}(f)/L_{raw}(f).

Weighting Multiple Modulations

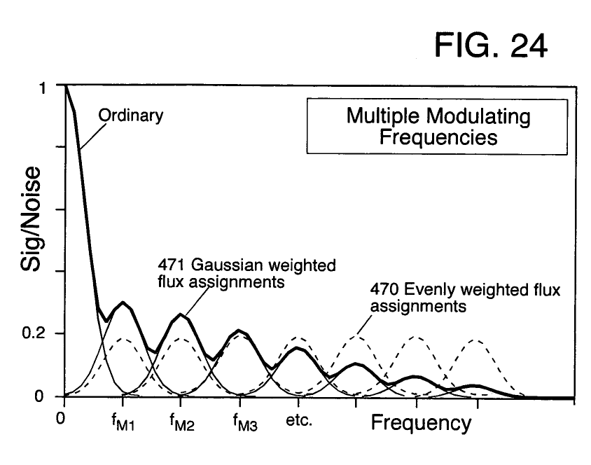

FIG. 24 plots the signal to noise ratio of an instrument having seven heterodyning frequencies, f_{M1} to f_{M7}, for two cases: where the each beats signal has equal weight (dashed curve 470), and where the beats are weighted differently with a Gaussian distribution (bold curve 471). Furthermore, it was assumed that the noise was due to shot noise of a fixed amount flux for the measurement, and that that flux is being subdivided into seven parts, one for each modulation frequency, and have different amounts of flux according to the aforementioned weighting scheme (even, or Gaussian). This is why the beat peaks are smaller than the 50% beat height of the single modulation case, FIG. 22A. For the evenly weighted case, the flux subdivided seven times would produce \sqrt{7} times more shot noise. Hence the peaks are at altitude 0.5/\sqrt{7}. And similarly for the Gaussian case, the sum of the squares of the seven beat heights equals 0.5 squared.

The usefulness for Gaussian weighting is that it anticipates the Gaussian shape desired for the overall response, so that the equalization necessary for curve 471 is approximately the same for all beat frequencies, so that the noise after equalization is approximately uniform versus frequency, also called “white”. In the even weighting scheme 470, in contrast, in order to produce an overall shape that is Gaussian, the higher frequency beat contributions must be severely attenuated by the equalization. This diminishes the noise at high frequency much more than at low frequency, producing “colored” noise. However, white noise can be preferable because it is the standard by which instrument performance is compared.

Optical Spectroscopy Example

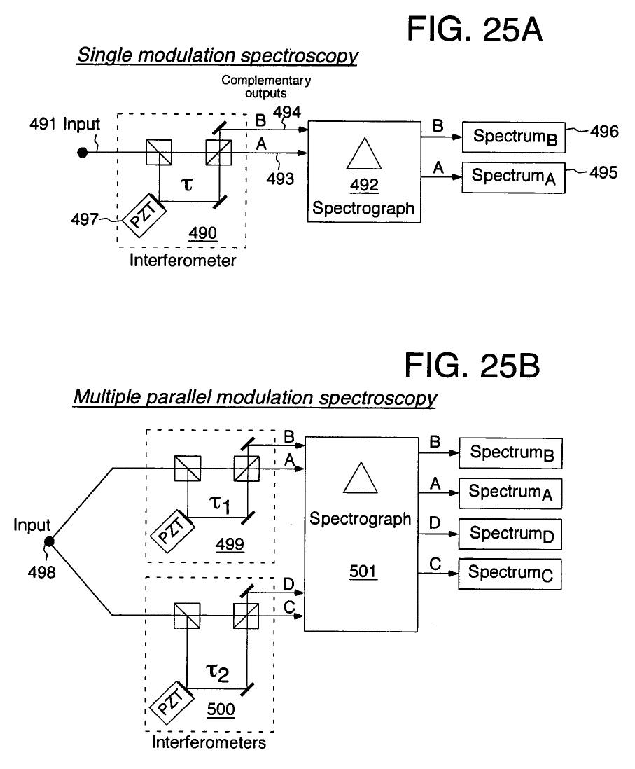

FIG. 25A is a schematic of an instrument using a single modulating “frequency” to measure an optical spectrum, which is analogous to the high resolution time recording we have been discussing. The interferometer 490 performs the function of 111 in FIG. 7 by creating a sinusoidal modulation versus wavenumber ν on the input light 491 which it outputs at two complementary outputs 493 A and 494 B, (where ν=1/λ, and is in units of cm⁻¹), where the interferometer delay τ is analogous to modulation frequency f_{M}, ν is analogous to time t, and the spectrograph 492 which records the spectrum versus ν is analogous to the time recorder 26 of FIG. 1. The delay τ is analogous to f_{M} because the interferometer creates a spatial frequency along the dispersion axis of the spectrograph. The greater the value of τ, the finer the periodicity of the modulation. Spectral features in the light 491 which have a width Δν which is similar to 1/τ will produce beats in the spectrum, which are recorded along with the ordinary component of the spectrum on the detector at 495 and 496 corresponding to the two output channels A and B.

These can be two adjacent areas on the same detector CCD chip. The two output channels 493 A and 494 B are out of phase by ½ cycle, and the sum of their outputs equals the input 491 (mirror loss is neglected). The phase φ of the interferometer, which shifts the phase of outputs A and B by the same amount, can be stepped by the PZT transducer 497 which moves an interferometer optic so that τ is slightly changed. By taking an exposure of spectrums A and B at φ=0, and another at φ=¼ cycle, effectively four channels of phase are created at 0, ½, ¼ and ¾ phases. This is a sufficient number of phase channels to do the phase stepping analysis to separate the beat and ordinary components.

Data can also be taken with a single output in sequential exposures while the delay is stepped to produce the needed multiple phase channels (called sequential-uniphase mode). This is appropriate for measuring spectra that are not changing rapidly relative to the phase stepping. Thirdly, a single output beam can be used in a single multiphase exposure if the phase varies across output beam by at least ⅔ cycle, such as by tilting an interferometer mirror.

Then performing the signal reconstruction of Part 2 can recover the spectrum to higher spectral resolution than if the spectrograph 492 was used alone without the interferometer 490. This is useful because higher resolution conventional spectrographs are larger and more expensive.

Furthermore, the same instrument and data can be used to measure Doppler shifts of the spectrum, by measuring the phase shift of the beats, which shift in phase proportionally to Doppler velocity of the light source. This is useful because it allows a small inexpensive low resolution spectrograph, in combination with an inexpensive interferometer, perform a Doppler measurement that is normally restricted to a more expensive larger spectrograph.

Usually a spectral reference such as an iodine absorption cell or ThAr lamp is measured simultaneously to remove the effect of a drift in τ. The phase shift of the target spectrum beats minus the phase shift of the reference spectrum beats is proportional to the Doppler velocity. The constant of proportionality is related to how many wavelengths of light fit into τ (which is in units of distance, usually centimeters). One cycle of beat phase shift corresponds to a Doppler velocity of c(λ/τ), where c is the speed of light.

The diagram 490 is topological—the actual interferometer design includes Mach-Zehnder and Michelson types, such as the wide angle Michelson design 73 of FIG. 5B.

Multiple Parallel Heterodyning

FIG. 25B is a scheme for implementing multiple modulating frequencies in a parallel manner, where the same input signal 498 is shared among several single modulating instruments, represented by the interferometers 499 and 500 having different delays τ₁, τ₂. These could share the same optical spectrograph 501 if the interferometer outputs are imaged to separate but parallel portions of the detecting CCD chip. If there are m modulating frequencies than the input light flux will be subdivided into 1/m smaller fluxes for each component instrument if there is equal flux weighting. Then the signal to noise ratio, for shot noise, for each beat component of the frequency response will be poorer than the single modulation case by a factor of 1 over square root of m. (This was discussed in the seven-delay example of frequency response shown in FIG. 24.) The advantage of having multiple modulation is a greater resolution increase. The requirement of three or more independent phase channels applies independently to each modulation frequency.

When multiple modulation frequencies are used, the signal reconstruction steps 1 to 6 that pertain to the beats are applied to each beats signal individually. For example an individual mask function designed for each particular beats signal is applied. Then in step 7 the mask ordinary signal and all the masked beats signals are summed together. The next steps of equalization and inverse Fourier transforming are the same.

Multiple Series Heterodyning

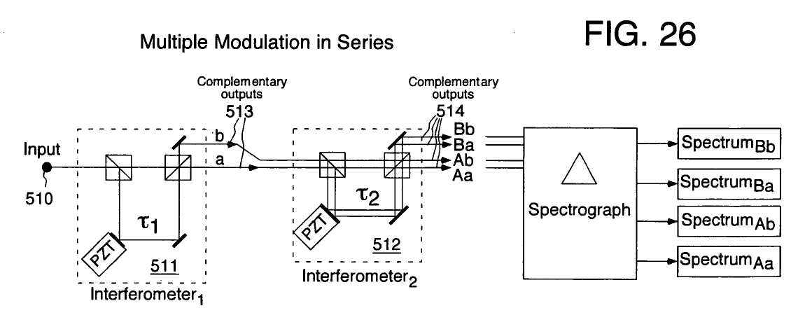

A multiple modulation scheme that avoids the shot noise increase of the parallel scheme is to have the multiple modulators (interferometers) in series, instead of in parallel, so that the same net flux is passed through each modulator stage. This is illustrated in FIG. 26 for the optical spectroscopy application, for the case of two interferometers in series having delays τ₁ and τ₂. Both of the two complementary outputs of each interferometer must pass through every downstream interferometer, so that summing all outputs at any given stage will yield the input signal 510. After the first interferometer 511 we have outputs a and b at 513. Each of these is split again by the second interferometer 512 to produce four outputs Aa, Ab, Ba and Bb at 514. (Consequently there is a geometric (binary tree) growth in the number outputs versus number of modulations, which will make the method problematic to implement optically as the number of modulations is more than a few.)

The method works because summing all the outputs of a given interferometer effectively “removes” the interferometer from the chain. And this summation can occur during data analysis, after the individual data channels are recorded. Different combinations of summation can be performed on the same net input flux, so the shot noise is the same for each modulation. For the spectroscopy application of FIG. 26 the data are spectra. For the analogous time recording application the data are signals recorded versus time.

We can make the first interferometer disappear by forming output sums (Aa+Ab) and (Ba+Bb), and make the second interferometer disappear by forming output sums (Aa+Ba) and (Ab+Bb). An analogous combinatorial schedule exists for more than two interferometers.

If an interferometer has two outputs A and B, then the sum (A+B) must equal the input flux to the interferometer, by conservation of energy, (neglecting mirror loss). The transmission of complementary outputs Tₐ and T_{b} of an idealized first interferometer are
Tₐ=(0.5)(1+cos 2πτ₁ν) and T_{b=(}0.5)(1−cos 2πτ₁ν) Eqn. 33
So that Tₐ+T_{b}=1. Similarly for the 2nd interferometer
T_{A}=(0.5)(1+cos 2πτ₂ν) and T_{B}=(0.5)(1−cos 2πτ₂ν) Eqn. 34
So that T_{A}+T_{B}=1. For interferometers in series the individual transmissions multiply. Hence we have four outputs T_{Aa}=T_{A}Tₐ, T_{Ab}=T_{A}T_{b} etc.

We isolate the 1st interferometer by adding the (Aa+Ba) data, which is equivalent to a transmission
T=T_{Aa}+T_{Ba}=Tₐ(T_{A}+T_{B})=Tₐ Eqn. 35
Similarly we obtain T_{b}. We isolate the 2nd interferometer by adding the (Aa+Ab) data together, which is equivalent to a transmission
T=T_{Aa}+T_{Ab}=T_{A}(Tₐ+T_{b})=T_{A} Eqn. 36

The benefit is that we recover the single-modulation data, for both τ₁ and τ₂, as if the full flux was used, not the subdivided flux of a parallel multiple modulation apparatus. This achieves a square root of m improvement in the shot signal to noise ratio for an m modulation frequency heterodyning instrument. The summations above can also be performed under various combinations of phase stepping, since the sum of phased transmissions T_{A}+T_{B}+T_{C} etc. is a constant.

Similarly this method will work for more than two modulators (interferometers). Suppose the eight outputs of three modulators in series are labeled Aa1, Aa2, Ab1, Ab2, . . . Bb2. We isolate the 1st interferometer by adding the (Aa1+Ab1+Aa2+Ab2) data because then the T_{A} transmission will factor out while the others sum to a constant:
T=T_{Aa1}+T_{Ab1}+T_{Aa2}+T_{Ab2}=T_{A}(Tₐ₁+T_{b1}+Tₐ₂+T_{b2})=T_{A} Eqn. 37
Because (Tₐ₁+T_{b1}+Tₐ₂+T_{b2})=1 by conservation of energy (flux).

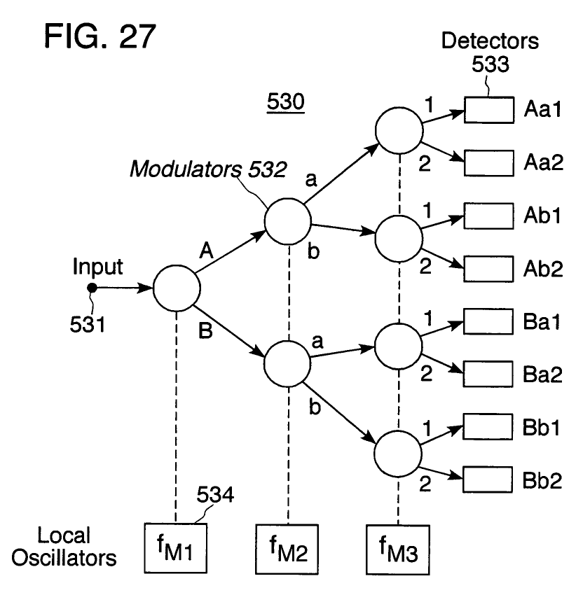

FIG. 27 is an embodiment of a multiple modulator scheme (tree network 530) having three stages, labeled (A/B, a/b, and ½), such as in an electronic apparatus for measuring a fast electrical signal 531 to higher time resolution than possible with the detectors 533 used alone. Every output of each modulator is passed to a modulator of the next stage, and so on, growing in number geometrically, and eventually each output of the last stage is detected in a separate channel. A modulator 532 is a device which can imprint a sinusoidal gain on its outputs at a specified frequency f_{M}, 534 etc. and where the sum of its outputs is equal to its input (except for some ordinary loss, ordinary because the loss does not oscillate versus t). The modulator and network technology is not limited to electronics, but could include other methods for encoding information such as the polarity of the spin of an electron or hole, or the charge state of a chemical molecule etc.

There could be more than two outputs to a modulator, such as three. Having three outputs per modulator may help in achieving the minimum three independent phase channels per modulation frequency needed during phase stepping data analysis.

Alternatively, this phase requirement can be achieved by subdividing the input flux into more than one parallel tree networks, each similar to that in FIG. 27, but having their modulation frequencies phase shifted. For example, having a second tree network in parallel to that in FIG. 27 but having its f_{M1}, f_{M2}, and f_{M3} shifted by ¼ cycle from the first network will, together with the first network, proved four channels of ¼ cycle step data for each modulation frequency.

If modulation frequencies for the embodiment 530 f_{M1}, f_{M2}, f_{M3} are in an approximate arithmetic sequence, so that in frequency space they contiguously cover, shoulder-to-shoulder, a large range of frequencies, such as 470 or 471 in FIG. 24, then the embodiment can act as single shot signal recorder that has a higher bandwidth, i.e. better time resolution, than any of the detectors used without heterodyning, and having a greater shot-noise signal to noise ratio than if the input flux was subdivided into a multitude of parallel channels. The effective bandwidth will be approximately set by the highest modulation frequency. The modulating signals are optimally sinusoidal instead of rectangular digital signals, so that unwanted harmonics are not made.

The choice of modulation frequencies is not limited to a contiguous coverage from zero to some maximum. If the frequency content of an expected signal is already known approximately, then the modulation frequencies can be optimally chosen to fill the bandwidth of the expected signal, and can leave gaps if necessary in frequency regions where the expected signal is weaker compared to noise.

Heterodyning Velocity Interferometry

An important diagnostic in national laboratories is the Doppler velocity interferometer (acronym “VISAR”), which passes a single channel of light reflected from a target through an interferometer that has multiple phase outputs. The interferometer creates fringes, whose shift in phase is proportional to the target Doppler velocity. The interferometer outputs are typically recorded either by discrete multiple detecting channels (with a photodiode or photomultiplier for each channel, usually four at ¼ cycle interval), or a streak camera where the phase of the interferometer (by tilting an interferometer mirror) is spread over many cycles across the streak camera photocathode and recorded in multiple channels. In the latter, it is typical that the spatial position along the target is also imaged along the photocathode, so that phase and position are convolved. It is equivalent to consider each spatial position along the target has three or four phase channels underneath a “superpixel” of spatial resolution, and the superpixel is necessarily three or four times larger than a fundamental pixel.

The typical application of a VISAR is to measure the sharp jump in velocity created by a shock wave, by measuring the passage of fringes versus time. (Example data is 130 of FIG. 13C.) The risetime of this shock can be much shorter than the response time of the detectors or streak camera. This blurs fringes in the edge region 131 of the measured velocity profile, making it difficult to determine exactly where the velocity jumps has occurred in time. Furthermore, this signal can change by several whole fringes, plus a fractional part, during the velocity jump. Due to the detector blurring the integer number of fringe “skips” during the jump is usually unresolvable and unknown. This is frustrating because at the shock front, exactly where one needs to know what the velocity is doing, the fringes disappear due to blurring. And elsewhere, before and after the shock, the fringes are easily resolvable, but there the time information is less important since the physics under study does not occur there.

The solution offered by this invention is to modulate the illumination sinusoidally at frequency f_{M}. This shifts the high frequency information of the shock front where the fringes are passing rapidly, to lower frequencies, where they can be better resolved by the detector. Such a heterodyning apparatus is useful because it increases the effective time resolution of the measurement beyond that without modulation. Two versions of the instrument are discussed, one where multiphase modulation is used for the illumination, and one where a single phase modulation is used.

Summary of Fundamental Equations

It is helpful to compare three different kinds of heterodyning, all involving multiple phase in either illumination or detection or both. The expressions for the real valued data recorded at the multichannel recorder will be given.

For the heterodyning discussed quite earlier, which employs multiphase modulation and real-valued data to measure the intrinsic signal S₀(t), then each nth data channel is modeled as
Iₙ(t)={1+cos(2πf_{M}t+2πφₙ)}S₀(t)\textcircled{×}D(t) Eqn. 38
Where “\textcircled{×}” is the convolution operator and D(t) is the impulse response of the detector, so the “\textcircled{×}D(t)” represents the effect of detector blurring. The blurring effect can be ignored for the discussion of phase stepping but is relevant for signal reconstruction. A visibility parameter γₙ and a factor of (½) in front of the cosine term has been omitted for simplicity, and for the equations below.

When the effective “signal” being measured by the detecting interferometer 92 is itself a complex quantity, denoted W₀(t), then additional multiple detecting phases ψ are needed to determine its complex character, because all data on the recorder 98 is obviously real-valued. Let us denote the real value of the jth phase channel of W₀(t) as (1+Re{W₀(t)e^{-i2πψ}^{ⱼ}}), so that the measured channel for a particular combination of φₙ and ψⱼ is
I_{n,j}(t)={1+cos(2πf_{M}t+2πφₙ)}(1+Re{W₀(t)e^{-i2πψ}^{ⱼ}})\textcircled{×}D(t) Eqn. 39
where the convolution operates on the whole product to the left of it. This equation governs the heterodyning velocity or displacement interferometry when multiphase illumination is used, where W₀(t) is the detecting interferometer (92 or 102) fringe signal, where the phase angle of W₀(t) is proportional to the target 91 Doppler velocity or target 101 displacement.

For an apparatus that only uses a single phase of illumination, and yet has multiple detecting phases ψⱼ from a velocity or displacement interferometer, then we have for the jth channel
Iⱼ(t)={1+cos(2πf_{M}t)}(1+Re{W₀(t)e^{-i2πψ}^{ⱼ}})\textcircled{×}D(t) Eqn. 40
The cases involving Eqn. 39 and 40 are elaborated below.
Multiphase Illumination on Multiphase Detection

An apparatus that uses multiphase illumination together with a multiphase recorded interferometer is governed by Eqn. 39. Let φₙ be the phase of the nth illumination channel out of k in number, and ψⱼ be the phase of the jth output channel of the detecting interferometer (92 or 102) out of q in number, for a total number of data channels of k times q.

Data analysis: For each φₙ channel we use the set of ψⱼ channel real data I_{n,j}(t) in a phase stepping algorithm (where ψ plays the role of φ) to find a Wₛₜₑₚ(t), which represents a complex W(t) associated with that n. (Eqn. 41 below is an example phase stepping algorithm.) We take that set of Wₙ(t) as inputs and apply a phase stepping algorithm again, this time using phases φₙ, to produce another Wₛₜₑₚ(t), which is our final result for the beats component. The algorithm also outputs the ordinary component W_{ord}(t), which may be complex but otherwise is analogous to S_{ord}(t). Finally, the beats and ordinary components are sent to Part 2 for signal reconstruction.

Alternatively in the phase stepping algorithm, it may be possible to swap the order and perform the φₙ phase stepping first, one for each ψⱼ, then the 2nd phase stepping over the set of ψⱼ.

Single Phase Illumination with Multiphase Detection

Often the velocity 92 or displacement 102 interferometer output is recorded by a streak camera (replacing the multichannel recorder 98), where the spatial dimension along the detector slit is already used to record the phase ν of the interferometer (and sample spatial behavior) and therefore not available for recording multiple phases φ of the illumination. Therefore it is convenient to use single phase illumination modulation, such as shown in FIG. 6A in an apparatus for measuring target 91 Doppler velocities, and in FIG. 6B in an apparatus for measuring displacement of a target 101 (which acts as an interferometer mirror). (The salient difference is that in 99 the target 91 is external, and in 100 the target 101 is internal to the interferometer cavity. In both cases the phase of the interferometer is proportional to the desired measured quantity, velocity or displacement.)

Because only a single phase is used on illumination, the data analysis for separating beat and ordinary parts is not direct, even when the phases intervals are regular. However, this disadvantage may be outweighed by the hardware simplicity of not having to modulate more than a single channel, and not having to record the product of k times q number of channels (detecting times illumination channels) in the multichannel recorder.

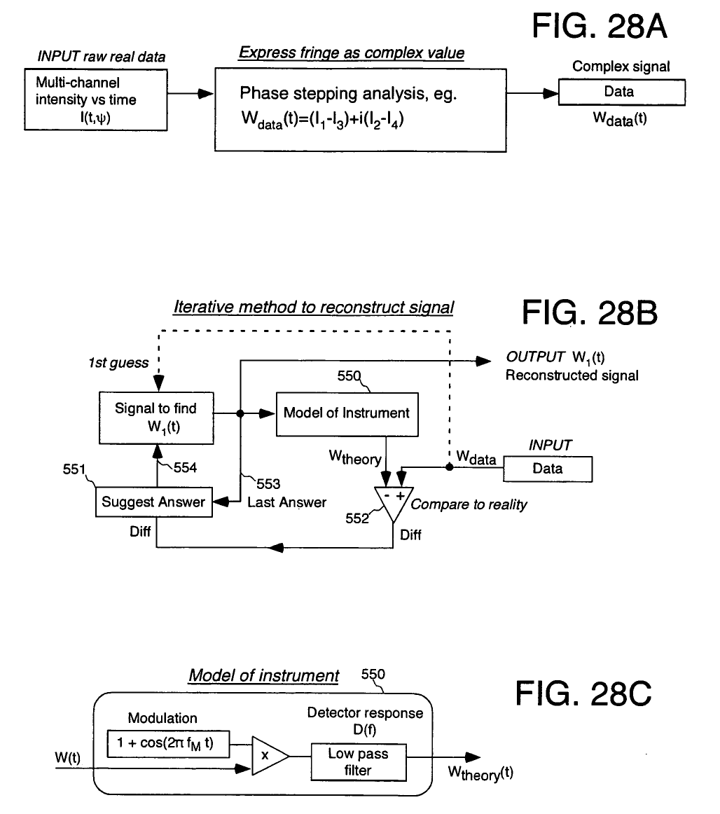

An apparatus that uses single-phase sinusoidal illumination together with a multiphase recorded interferometer is governed by Eqn. 40. Data analysis: We use the set of ψⱼ channel data Iⱼ(t) in a phase stepping algorithm (where ψ plays the role of φ) to find a Wₛₜₑₚ(t), which represents our complex data W_{data}(t). An example phase stepping algorithm (FIG. 28A) for a regular arrangement of four channels I₁, I₂, I₃ and I₄ at ¼ cycle steps is
W_{data}(t)={I₁(t)−I₃(t)}+i{I₂(t)−I₄(t)} Eqn. 41
The W_{data}(t) contains ordinary, beats and conjugate beats components. Because we have only a single phase of illumination we cannot directly separate these components, as we did with multiphase illumination. Instead, we use an iterative approach to arrive at a solution for the reconstructed signal W₁(t), which will be our measurement of the intrinsic signal W₀(t).

An iterative approach is diagrammed in FIG. 28B. The idea is that it is easier to calculate in the forward direction than in the reverse direction. The forward direction is when given W₀(t) and an instrument model 550 (shown in more detail in FIG. 28C), we calculate the theoretical output of the instrument W_{theory}(t). If the knowledge of W₀(t) and instrument theory is perfect, then W_{theory}(t) should agree perfectly with the measured W_{data}(t).

Denote our current best guess of W₀(t) as W₁(t). Initially we guess at W₁(t). Then we use the instrument model 550 to calculate a W_{theory}. At 552 we calculate the difference Diff(t)=W_{data}(t)−W_{theory}(t). Based on this Diff and the current W₁ we modify W₁ at a process box 551 called “Suggest Answer”, and then iteratively repeat the loop of recalculating in the forward direction until the magnitude of Diff reduces below some threshold (such as the level of noise in the data).

For an initial guess at W₁(t), we can use the data itself, W_{data}(t), since this will agree with W₀(t) for low frequencies and differ only in the high frequency regions, which for a shock like fringe signal 130 (of FIG. 8C) is limited to a narrow region 131.

FIG. 28B diagrams a theoretical model of the instrument,
W_{theory}(t)={(1+cos(2πf_{M}t))W₀(t)}\textcircled{×}D(t) Eqn. 42
which is related to Eqn. 40 but uses complex input and output signals, which removes the need to specify the phase stepping. A calibration measurement can provide an estimate for D(f) used in the model.

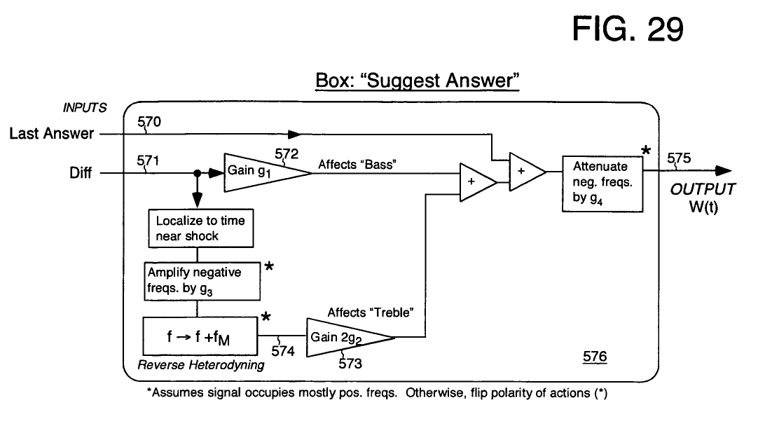

FIG. 29 diagrams details 576 inside process box “Suggest Answer” 551, which accepts signals of Diff(t) and the current value of W₁(t), called “Last Answer” 553 and 570, and outputs an updated version of W₁(t) 554 and 571. Parameters which the user can adjust to optimize rapid convergence to a solution include the gain g₁ at amplifier 572, which affects the Diff signal and hence primarily the ordinary component, and the gain g₂ at amplifier 573, which affects the treble component 574. The latter is obtained from Diff 571 by 1. (optionally) localizing it in time to the shock region 131, since this is where the treble signal is largest relative to the bass; 2. Amplify negative frequencies by an adjustable amount g₃. 3. Reverse the heterodyning by Fourier transforming, translating the frequencies by f_{M} toward positive frequencies, then inverse Fourier transforming.

After the treble and bass signals have been amplified by g₁ and g₂, they are summed with “Last Answer”, and then attenuated by an adjustable amount g₄ to form the output at 575. The use should experiment with different values of the gains g₁, g₂, g₃, g₄ to optimize rapid convergence to a solution. The steps above assumed that the treble signal in the shock region occupied mostly positive frequencies, which depends on how positive fringe phase is defined. If not the case, force the frequencies to be mostly positive by taking the complex conjugate of W_{data}.

The above “Suggest Answer” process details 576 work well for shock like fringe signals that are localized in time. For other types of signals these details may optimally be different.

While particular operational sequences, materials, temperatures, parameters, and particular embodiments have been described and or illustrated, such are not intended to be limiting. Modifications and changes may become apparent to those skilled in the art, and it is intended that the invention be limited only by the scope of the appended claims.

I claim:

1. A method for increasing the temporal resolution of an optical detector measuring the intensity versus time of an intrinsic optical signal S₀(t) of a target having frequency f, so as to enhance the measurement of high frequency components of S₀(t), said method comprising:
illuminating the target with a set of n phase-differentiated channels of sinusoidally-modulated intensity Tₙ(t), with n≧3 and modulation frequency f_{M}, to produce a corresponding set of optically heterodyned signals S₀(t)Tₙ(t);
detecting a set of signals Iₙ(t) at the optical detector which are the optically heterodyned signals S₀(t)Tₙ(t) reaching the detector but blurred by the detector impulse response D(t), expressed as
Iₙ(t)={S₀(t)Tₙ(t)}\textcircled{×}D(t)=S_{ord}(t)+I_{n,osc}(t), where S_{ord}(t) is an ordinary signal component and I_{n,osc}(t) is an oscillatory component comprising a down-shifted beat component and an up-shifted conjugate beat component;
in a phase stepping analysis, using the detected signals Iₙ(t) to determine an ordinary signal S_{ord,det}(t) to be used for signal reconstruction, and a single phase-stepped complex output signal Wₛₜₑₚ(t) which is an isolated single-sided beat signal;
numerically reversing the optical heterodyning by transforming Wₛₜₑₚ(t) to Wₛₜₑₚ(f) and S_{ord,det}(t) to S_{ord,det}(f) in frequency space, and up-shifting Wₛₜₑₚ(f) by f_{M} to produce a treble spectrum W_{treb}(f), where W_{treb}(f)=Wₛₜₑₚ(f−f_{M});
making the treble spectrum W_{treb}(f) into a double sided spectrum S_{dbl}(f) that corresponds to a real valued signal versus time S_{dbl}(t);
combining the double sided spectrum S_{dbl}(f) with S_{ord,det}(f) to form a composite spectrum Sᵤₙ(f);
equalizing the composite spectrum Sᵤₙ(f) to produce S_{fin}(f); and
inverse transforming the equalized composite spectrum S_{fin}(f) into time space to obtain S_{fin}(t) which is the measurement for the intrinsic optical signal S₀(t).

2. The method of claim 1,
wherein the step of determining the ordinary signal S_{ord,det}(t) includes:
normalizing each detected signal Iₙ(t) so that its value averaged over time is the same for all detected signals;
finding a set of channel weightings Hₙ which produces a zero vector sum for a residual vector \vec{R}, where
$${R}^{->} = {\sum }_{n} {H}_{n} {{P}^{->}}_{n} ,$$
and \vec{P}ₙ=γₙe^{-i2πφ}^{ₙ} where \vec{P}ₙ are pointing vectors representing the visibility and phase angle of a corresponding detected signal Iₙ(t), while holding the average Hₙ constant, so as to produce a balanced condition to eliminate the beat component and any conjugate beat components; and
using the set of channel weightings Hₙ, to produce a weighted average
$${S}_{Wavg} ( t ) = \frac{{\sum }_{n} {H}_{n} {I}_{n} ( t )}{{\sum }_{n} {H}_{n}} ,$$
representing the determined ordinary signal S_{ord,det}(t).

3. The method of claim 2,
wherein, in the case where the pointing vectors \vec{P}ₙ are known or unknown, the step of finding a set of channel weightings Hₙ which produce the balanced condition includes finding a set of channel weightings Hₙ which minimizes the variance in the weighted average S_{Wavg}(t) of all the illumination channel data.

4. The method of claim 3,
wherein the step of finding a set of channel weightings Hₙ which minimizes the variance in the weighted average S_{Wavg}(t) of all the detected signals Iₙ(t) includes:
(a) iteratively testing every detected signal Iₙ(t) to identify which Hₙ has the strongest magnitude of effect on the variance, represented as Hₘ;
(b) moving the identified Hₘ by an amount ΔH to the position that minimizes the variance, while moving all the other Hₙ in the other direction by a smaller amount ΔH/(k−1), so that the average Hₙ for all detected signals Iₙ(t) is unchanged; and
(c) repeating steps (a) and (b) until the variance no longer decreases significantly.

5. The method of claim 3,
wherein the step of finding a set of channel weightings Hₙ which minimizes the variance in the weighted average S_{Wavg}(t) includes reducing the number of degrees of freedom to two by ganging several channels together so that they move in a fixed ratio.

6. The method of claim 3,
further comprising choosing a large time interval over which the variance is calculated to minimize crosstalk between the ordinary and beat signals.

7. The method of claim 2,
wherein, in the case where the pointing vectors \vec{P}ₙ are known, the step of finding a set of channel weightings Hₙ which produce the balanced condition includes iteratively selecting Hₙ by inspection and directly evaluating the residual vector \vec{R}.

8. The method of claim 7,
wherein the pointing vectors \vec{P}ₙ are known by finding the phase angle and visibility thereof according to the equations:
\vec{P}ₙ={I_{n,osc}(t)·Q(t)}+i{I_{n,osc}(t)·Q_{⊥}(t)},
tan φₙ={I_{n,osc}(t)·Q_{⊥}(t)}/{I_{n,osc}(t)·Q(t)}, and
γₙ²={I_{n,osc}(t)·Q_{⊥}(t)}²+{I_{n,osc}(t)·Q(t)}², where Q(t) is a normalized reference signal where Q(t)·Q(t)=1, and Q(t)·Q_{⊥}(t)=0 such that Q(t) has minimal or no crosstalk with the conjugate component.

9. The method of claim 8,
wherein the normalized reference signal Q(t) is selected so that it has a zero or small dot-product with the conjugate beat component so that it only senses the beat component.

10. The method of claim 9,
wherein a current best estimate of the best signal is selected as the normalized reference signal Q(t).

11. The method of claim 9,
wherein the normalized reference signal Q(t) is filtered so that it is only sensitive to a frequency band known to contain mostly the beat component.

12. The method of claim 9,
further comprising choosing a large time interval to minimize crosstalk between the normalized reference signal Q(t) and the conjugate component.

13. The method of claim 1,
wherein the step of determining a single phase-stepped complex output signal Wₛₜₑₚ(t) includes, for each detected signal Iₙ(t), isolating the oscillatory component I_{n,osc}(t) by subtracting the determined ordinary signal component S_{ord,det}(t) from the corresponding Iₙ(t), and combining the set of all oscillatory components I_{n,osc}(t) to cancel the conjugate beat components therein.

14. The method of claim 13,
wherein the step of combining the set of oscillatory components I_{n,osc}(t) cancel the conjugate beat components therein and form a single phase-stepped complex output Wₛₜₑₚ(t) includes:
finding the phase angles and visibilities for the oscillatory components I_{n,osc}(t) according to the equations:
\vec{P}ₙ={I_{n,osc}(t)·Q(t)}+i{I_{n,osc}(t)·Q_{⊥}(t)},
tan φₙ={I_{n,osc}(t)·Q_{⊥}(t)}/{I_{n,osc}(t)·Q(t)}, and
γₙ²={I_{n,osc}(t)·Q_{⊥}(t)}²+{I_{n,osc}(t)·Q(t)}², using a normalized reference signal Q(t) where Q(t)·Q(t)=1, and Q(t)·Q₁₉₅(t)=0 such that Q(t) has minimal or no crosstalk with the conjugate beat component.
rotating the oscillatory components I_{n,osc}(t) by applying phasors e^{i2πθ}^{ₙ}, using angles θₙ=−φₙ, chosen to bring the pointing vectors of the beat components into alignment so that they point in the same direction; and
using at least one of a rotational method and a changing weights method applied to I_{n,osc}(t) to bring the pointing vectors of the conjugate beat components into a balanced configuration for cancellation, and the pointing vectors of the beat components into an unbalanced configuration.

15. The method of claim 14,
wherein if the rotational method is used, a set of rotations Ωₙ are applied to selected channels of I_{n,osc}(t) with the rotational angles chosen to produce a balanced condition for the pointing vectors of the conjugate beat components while simultaneously producing an strongly unbalanced configuration for the pointing vectors of the beat components, by satisfying the equations:
$${R}_{cnj} = {\sum }_{n} {γ}_{n} {ⅇ}^{- {ⅈ2πΩ}_{n}} {ⅇ}^{ⅈ2π ( 2 {ϕ}_{n} )} = 0$$
for producing a balanced conjugate, and
$${\sum }_{n} {γ}_{n} {ⅇ}^{- {ⅈ2πΩ}_{n}} \neq 0$$
for producing an unbalanced beats term, and the sum of all the thus rotated signals I_{n,osc}(t) produces a canceled conjugate beat term and an un-canceled beat term, expressed as the phase stepped output
$${W}_{step} ( t ) = {\sum }_{n} {I}_{n , osc} ( t ) {ⅇ}^{- {ⅈ2πΩ}_{n}} {ⅇ}^{- {ⅈ2πθ}_{n}} .$$

16. The method of claim 15,
further comprising selecting for rotation those channels of I_{n,osc}(t) which have large magnitudes of dot product between R_{⊥cnj} and each pointing vector \vec{P}ₙ, where R_{⊥cnj} is the perpendicular of R_{cnj} expressed as R_{⊥cnj}=−iR_{cnj}, and rotating the selected channels of I_{n,osc}(t) until the magnitude of R_{cnj} is minimized.

17. The method of claim 16,
further comprising iteratively repeating the steps of claim 16 until R_{cnj} becomes insignificantly small.

18. The method of claim 14,
wherein if the changing weights method is used, then the pointing vectors of the conjugate beat components are brought into a balanced configuration for cancellation and the pointing vectors of the beat components are brought into an unbalanced configuration by finding a set of channel weightings Hₙ which produces the balanced condition for only the conjugate beat components, and the sum of all the thus rotated and weighted channel data produces a canceled conjugate beat term with an un-canceled beat term, expressed as the phase stepped output
$${W}_{step} ( t ) = {\sum }_{n} {H}_{n} {I}_{n , osc} ( t ) {ⅇ}^{- {ⅈ2πθ}_{n}} .$$

19. The method of claim 18,
wherein the step of finding a set of channel weightings Hₙ which produces the balanced condition for only the conjugate beat components includes finding a set which minimizes the variance in the conjugated beat components and not the beat components.

20. The method of claim 19,
wherein the step of finding a set which minimizes the variance in the conjugated beat components and not the beat components includes temporarily filtering I_{n,osc}(t) to a band of frequencies known to have the conjugate beats much stronger than the beats.

21. The method of claim 18,
wherein the step of finding a set of channel weightings Hₙ which produces the balanced condition for only the conjugate beat components includes minimizing the sum of pointing vectors that represent the isolated beats, by minimizing the magnitude of the residual vector \vec{R}, where
$${R}^{->} = {\sum }_{n} {H}_{n} {{P}^{->}}_{n} , and {{P}^{->}}_{n} = {γ}_{n} {ⅇ}^{- {ⅈ2πϕ}_{n}} ,$$
where the reference signal Q(t) used to compute \vec{P}ₙ in the equation \vec{P}ₙ{=I_{n,osc}(t)·Q(t)}+i{I_{n,osc}(t)·Q_{⊥}(t)} is optimally sensitive only to the beats and not to the conjugate beats.

22. The method of claim 14,
wherein the step of combining the set of oscillatory components I_{n,osc}(t) to cancel the conjugate beat components therein and form a single phase-stepped complex output Wₛₜₑₚ(t) further includes rotating and normalizing Wₛₜₑₚ(t) so it is aligned with and has the same magnitude as a designated reference signal.

23. The method of claim 22,
wherein designated reference signal is Q(t) used to determine phase angles and visibilities.

24. The method of claim 1,
further comprising preparing the data prior to numerically reversing the optical heterodyning, by performing at least one of removing warp and resampling/rebinning the data.

25. The method of claim 24,
wherein the rebinning step includes Fourier transforming the data into frequency-space, padding the right (higher frequencies) with zeros so that the maximum frequency on the right, called the Nyquist frequency, is increased, and inverse Fourier transforming back to time-space.

26. The method of claim 24,
wherein the dewarping step includes removing any nonlinearities in the time axis, if present, so that the modulation is perfectly sinusoidal with constant frequency across all time.

27. The method of claim 1,
further comprising rotating the treble spectrum W_{treb}(f) in phase so that it is in proper alignment with the other components, including the ordinary component and treble components from other modulation frequencies if they are used.

28. The method of claim 27,
further comprising determining the amount of in-phase rotation of the treble spectrum W_{treb}(f) from a calibration measurement of a known signal that is performed by the instrument either at the same time on other recording channels, or soon after the main measurement before the instrument characteristics have time to change.

29. The method of claim 1,
further comprising deleting a comb spike and everything else at negative frequencies prior to making the treble spectrum W_{treb}(f) into the double sided spectrum S_{dbl}(f).

30. The method of claim 1,
wherein the treble spectrum W_{treb}(f) is made into the double sided spectrum S_{dbl}(f) by copying the complex conjugate of W_{treb}(f) to the negative frequency branch, and flipping the frequencies so that the real valued signal S_{dbl}(t) is formed.

31. The method of claim 30,
wherein the treble spectrum W_{treb}(f) is made into the double side spectrum S_{dbl}(f) by taking the inverse Fourier transform of W_{treb}(f), setting the imaginary part to zero, and then Fourier transforming it back to frequency space.

32. The method of claim 1,
further comprising masking away the low frequency areas of S_{dbl}(f) where its signal is expected to be small relative to the ordinary detected spectrum S_{ord,det}(f) to delete noise, and masking away the high frequency areas of S_{ord}(f) to delete noise in frequency regions where its signal is expected to be small and noisy.

33. The method of claim 32,
wherein the masking is accomplished by multiplication by user defined functions M_{ord}(f) and M_{beat}(f).

34. The method of claim 1,
wherein the composite spectrum Sᵤₙ(f) is equalized by multiplying Sᵤₙ(f) by an equalization shape E(f), to form the equalized composite spectrum S_{fin}(f), where the E(f) magnifies the spectrum for frequencies in a valley region between a shoulder of the ordinary spectrum and f_{M}.

35. The method of claim 34,
wherein the equalization shape E(f) is the ratio E(f)=L_{goal}(f)/L_{raw}(f) except for a toe region, and L(f) is the instrument response which is the smoothed ratio between the measured spectrum and the true spectrum.

36. The method of claim 35,
wherein L_{goal}(f) is a Gaussian function centered at zero frequency, so that the instrument lineshape in time-space, which is the Fourier transform of L_{goal}(f), has minimal ringing.

37. The method of claim 35,
wherein the L_{raw}(f) is determined through calibration measurements on a known signal, and depends on γ, D(f), f_{M}, and masking functions M_{ord}(f) and M_{beat}(f).

38. The method of claim 1,
wherein the illumination is sinusoidally modulated with an oscillator.

39. The method of claim 1,
wherein the illumination is sinusoidally modulated with a moving mirror interferometer.

40. The method of claim 1,
wherein the illumination is sinusoidally modulated with an acousto-optic modulator.

41. The method of claim 1,
wherein a series of narrow pulses is used to produce a sinusoid-like modulation of the illumination.

42. The method of claim 41,
wherein the number of phase-differentiated illumination channels are selected to cancel certain undesired beat harmonics while preserving the fundamental beat.

43. The method of claim 1,
wherein the intensity of the illumination source is sinusoidally modulated by laser mode-beating between two frequency modes.

44. The method of claim 1,
wherein the illumination channels are distinguishably encoded by at least one of angle of incidence, wavelength, polarization, and spatial location on a target.

45. The method of claim 44,
wherein a moving mirror interferometer and a broad bandwidth illumination are used to encode the illumination channels by wavelength.

46. The method of claim 45,
wherein a wide angle interferometer is used to produce an angle-independent delay.

47. The method of claim 1,
further comprising illuminating the target with at least one additional set of n phase-differentiated channels of sinusoidally-modulated intensity, with n≧3 and a corresponding modulation frequency which is different from f_{M} and any other modulation frequency.

48. The method of claim 47
wherein the beats are weighted differently with a Gaussian distribution.

49. The method of claim 47,
wherein the different modulating frequencies are implemented in parallel.

50. The method of claim 47,
wherein the different modulating frequencies are implemented in series.

51. The method of claim 1,
wherein the modulation frequency f_{M} is selected to be similar to the frequency response f_{D} of the optical detector.

52. The method of claim 1,
Wherein the n phase-differentiated channels of sinusoidally-modulated intensity Tₙ(t) are phase shifted relative to each other by 360/n degrees.

53. The method of claim 52,
wherein n is selected from the group consisting of 3 and 4.

54. The method of claim 1,
wherein the optical detector is a multi-channel detector having a plurality of input channels assignable to different spatial locations on the target.

55. The method of claim 54,
wherein the optical detector is a streak camera.

56. A system for increasing the temporal resolution of an optical detector measuring the intensity versus time of an intrinsic optical signal S₀(t) of a target having frequency f, so as to enhance the measurement of high frequency components of S₀(t), said method comprising:
means for illuminating the target with a set of n phase-differentiated channels of sinusoidally-modulated intensity Tₙ(t), with n≧3 and modulation frequency f_{M}, to produce a corresponding set of optically heterodyned signals S₀(t)Tₙ(t);
an optical detector capable of detecting a set of signals Iₙ(t) which are the optically heterodyned signals S₀(t)Tₙ(t) reaching the detector but blurred by the detector impulse response D(t), expressed as Iₙ(t)={S₀(t)Tₙ(t)}\vec{×}D(t)=S_{ord}(t)+I_{n,osc}(t), where S_{ord}(t) is an ordinary signal component and I_{n,osc}(t) is an oscillatory component comprising a down-shifted beat component and an up-shifted conjugate beat component;
phase stepping analysis processor means for using the detected signals Iₙ(t) to determine an ordinary signal S_{ord,det}(t) to be used for signal reconstruction, and a single phase-stepped complex output signal Wₛₜₑₚ(t) which is an isolated single-sided beat signal;
processor means for numerically reversing the optical heterodyning by transforming Wₛₜₑₚ(t) to Wₛₜₑₚ(f) and S_{ord,det}(t) to S_{ord,det}(f) in frequency space, and up-shifting Wₛₜₑₚ(f) by f_{M} to produce a treble spectrum W_{treb}(f), where W_{treb}(f)=Wₛₜₑₚ(f−f_{M});
processor means for making the treble spectrum W_{treb}(f) into a double sided spectrum S_{dbl}(that corresponds to a real valued signal versus time S_{dbl}(t);
processor means for combining the double sided spectrum S_{dbl}(f) with S_{ord,det}(f) to form a composite spectrum Sᵤₙ(f);
processor means for equalizing the composite spectrum Sᵤₙ(f) to produce S_{fin}(f); and
processor means for inverse transforming the equalized composite spectrum S_{fin}(f) into time space to obtain S_{fin}(t) which is the measurement for the intrinsic optical signal S₀(t).

57. The system of claim 56,
wherein the phase stepping analysis processor means is adapted to determine the ordinary signal S_{ord,det}(t) by:
normalizing each detected signal Iₙ(t) so that its value averaged over time is the same for all detected signals;
finding a set of channel weightings Hₙ which produces a zero vector sum for a residual vector \vec{R}, where
$${R}^{->} = {\sum }_{n} {H}_{n} {{P}^{->}}_{n} ,$$
and \vec{P}ₙ=γₙe^{-i2πφ}^{ₙ} where \vec{P}ₙ are pointing vectors representing the visibility and phase angle of a corresponding detected signal Iₙ(t), while holding the average Hₙ constant, so as to produce a balanced condition to eliminate the beat component and any conjugate beat components; and
using the set of channel weightings Hₙ, to produce a weighted average
$${S}_{Wavg} ( t ) = \frac{{\sum }_{n} {H}_{n} {I}_{n} ( t )}{{\sum }_{n} {H}_{n}} ,$$
representing the determined ordinary signal S_{ord,det}(t).

58. The system of claim 57,
wherein, in the case where the pointing vectors \vec{P}ₙ are known or unknown, the phase stepping analysis processor means is adapted to find a set of channel weightings Hₙ which minimizes the variance in the weighted average S_{Wavg}(t) of all the illumination channel data.

59. The system of claim 58,
wherein the phase stepping analysis processor means is adapted to find a set of channel weightings Hₙ which minimizes the variance in the weighted average S_{Wavg}(t) of all the detected signals Iₙ(t) by:
(a) iteratively testing every detected signal Iₙ(t) to identify which Hₙ has the strongest magnitude of effect on the variance, represented as Hₘ;
(b) moving the identified Hₘ by an amount ΔH to the position that minimizes the variance, while moving all the other Hₙ in the other direction by a smaller amount ΔH/(k−1), so that the average Hₙ for all detected signals Iₙ(t) is unchanged; and
(c) repeating steps (a) and (b) until the variance no longer decreases significantly.

60. The system of claim 58,
wherein the phase stepping analysis processor means is adapted to find a set of channel weightings Hₙ which minimizes the variance in the weighted average S_{Wavg}(t) by reducing the number of degrees of freedom to two by ganging several channels together so that they move in a fixed ratio.

61. The system of claim 58,
wherein the phase stepping analysis processor means is adapted to choose a large time interval over which the variance is calculated to minimize crosstalk between the ordinary and beat signals.

62. The system of claim 57,
wherein, in the case where the pointing vectors \vec{P}ₙ are known, the phase stepping analysis processor means is adapted to iteratively select Hₙ by inspection and directly evaluating the residual vector \vec{R}.

63. The system of claim 62,
further comprising processor means for finding the phase angle and visibility of the pointing vectors \vec{P}ₙ according to the equations:
\vec{P}ₙ={I_{n,osc}(t)·Q(t)}+i{I_{n,osc}(t)·Q_{⊥}(t)},
tan φₙ={I_{n,osc}(t)·Q_{⊥}(t)}/{I_{n,osc}(t)·Q(t)}, and
γₙ²={I_{n,osc}(t)·Q_{⊥}(t)}²+{I_{n,osc}(t)·Q(t)}², where Q(t) is a normalized reference signal where Q(t)·Q(t)=1, and Q(t)·Q_{⊥}(t)=0 such that Q(t) has minimal or no crosstalk with the conjugate component.

64. The system of claim 63,
wherein the processor means for finding the phase angle and visibility of the pointing vectors \vec{P}ₙ is adapted to select the normalized reference signal Q(t) so that it has a zero or small dot-product with the conjugate beat component so that it only senses the beat component.

65. The system of claim 64,
wherein the processor means for finding the phase angle and visibility of the pointing vectors \vec{P}ₙ is adapted to select a current best estimate of the best signal as the normalized reference signal Q(t).

66. The system of claim 64,
wherein the processor means for finding the phase angle and visibility of the pointing vectors \vec{P}ₙ is adapted to filter the normalized reference signal Q(t) so that it is only sensitive to a frequency band known to contain mostly the beat component.

67. The system of claim 64,
wherein the processor means for finding the phase angle and visibility of the pointing vectors \vec{P}ₙ are adapted to select a large time interval to minimize crosstalk between the normalized reference signal Q(t) and the conjugate component.

68. The system of claim 56,
wherein the phase stepping analysis processor means is adapted to determine the single phase-stepped complex output signal Wₛₜₑₚ(t) by, for each detected signal Iₙ(t), isolating the oscillatory component I_{n,osc}(t) by subtracting the determined ordinary signal component S_{ord,det}(t) from the corresponding Iₙ(t), and combining the set of all oscillatory components I_{n,osc}(t) to cancel the conjugate beat components therein.

69. The system of claim 68,
wherein the phase stepping analysis processor means is adapted to combine the set of oscillatory components I_{n,osc}(t) to cancel the conjugate beat components therein and form a single phase-stepped complex output Wₛₜₑₚ(t) by:
finding the phase angles and visibilities for the oscillatory components I_{n,osc}(t) according to the equations:
\vec{P}ₙ={I_{n,osc}(t)·Q(t)}+i{I_{n,osc}(t)·Q_{⊥}(t)},
tan φₙ={I_{n,osc}(t)·Q_{⊥}(t)}/{I_{n,osc}(t)·Q(t)}, and
γₙ²={I_{n,osc}(t)·Q_{⊥}(t)}²+{I_{n,osc}(t)·Q(t)}², using a normalized reference signal Q(t) where Q(t)·Q(t)=1, and Q(t)·Q_{⊥(t)=}0 such that Q(t) has minimal or no crosstalk with the conjugate beat component.
rotating the oscillatory components I_{n,osc}(t) by applying phasors e^{i2πθ}^{ₙ}, using angles θₙ=−φₙ, chosen to bring the pointing vectors of the beat components into alignment so that they point in the same direction;
using at least one of a rotational system and a changing weights system applied to I_{n,osc}(t) to bring the pointing vectors of the conjugate beat components into a balanced configuration for cancellation, and the pointing vectors of the beat components into an unbalanced configuration.

70. The system of claim 69,
wherein if the rotational system is used, the phase stepping analysis processor means is adapted to apply a set of rotations Ωₙ to selected channels of I_{n,osc}(t) with the rotational angles chosen to produce a balanced condition for the pointing vectors of the conjugate beat components while simultaneously producing an strongly unbalanced configuration for the pointing vectors of the beat components, by satisfying the equations:
$${R}_{cnj} = {\sum }_{n} {γ}_{n} {ⅇ}^{- {ⅈ2πΩ}_{n}} {ⅇ}^{ⅈ2π ( 2 {ϕ}_{n} )} = 0$$
for producing a balanced conjugate, and
$${\sum }_{n} {γ}_{n} {ⅇ}^{- {ⅈ2πΩ}_{n}} \neq 0$$
for producing an unbalanced beats term, and the sum of all the thus rotated signals I_{n,osc}(t) produces a canceled conjugate beat term and an un-canceled beat term, expressed as the phase stepped output
$${W}_{step} ( t ) = {\sum }_{n} {I}_{n , osc} ( t ) {ⅇ}^{- {ⅈ2πΩ}_{n}} {ⅇ}^{- {ⅈ2πθ}_{n}} .$$

71. The system of claim 70,
wherein the phase stepping analysis processor means is adapted to select for rotation those channels of I_{n,osc}(t) which have large magnitudes of dot product between R_{⊥cnj} and each pointing vector \vec{P}ₙ, where R_{⊥cnj} is the perpendicular of R_{cnj} expressed as R_{⊥cnj}=−iR_{cnj}, and rotating the selected channels of I_{n,osc}(t) until the magnitude of R_{cnj} is minimized.

72. The system of claim 71,
wherein the phase stepping analysis processor means is adapted to iteratively repeat the steps of claim 71 until R_{cnj} becomes insignificantly small.

73. The system of claim 69,
wherein if the changing weights system is used, the phase stepping analysis processor means is adapted to bring the pointing vectors of the conjugate beat components into a balanced configuration for cancellation and the pointing vectors of the beat components into an unbalanced configuration by finding a set of channel weightings Hₙ which produces the balanced condition for only the conjugate beat components, and the sum of all the thus rotated and weighted channel data produces a canceled conjugate beat term with an un-canceled beat term, expressed as the phase stepped output
$${W}_{step} ( t ) = {\sum }_{n} {H}_{n} {I}_{n , osc} ( t ) {ⅇ}^{- {ⅈ2πθ}_{n}} .$$

74. The system of claim 73,
wherein the phase stepping analysis processor means is adapted to find a set of channel weightings Hₙ which produces the balanced condition for only the conjugate beat components by finding a set which minimizes the variance in the conjugated beat components and not the beat components.

75. The system of claim 74,
wherein the phase stepping analysis processor means is adapted to find a set which minimizes the variance in the conjugated beat components and not the beat components by temporarily filtering I_{n,osc}(t) to a band of frequencies known to have the conjugate beats much stronger than the beats.

76. The system of claim 73,
wherein the phase stepping analysis processor means is adapted to find a set of channel weightings Hₙ which produces the balanced condition for only the conjugate beat components by minimizing the sum of pointing vectors that represent the isolated beats, by minimizing the magnitude of the residual vector \vec{R}, where
$${R}^{->} = {\sum }_{n} {H}_{n} {{P}^{->}}_{n} , and {{P}^{->}}_{n} = {γ}_{n} {ⅇ}^{- i2 π {ϕ}_{n}} ,$$
where the reference signal Q(t) used to compute \vec{P}ₙ in the equation \vec{P}ₙ={I_{n,osc}(t)·Q(t)}+i{I_{n,osc}(t)·Q_{⊥}(t)} is optimally sensitive only to the beats and not to the conjugate beats.

77. The system of claim 69,
wherein the phase stepping analysis processor means is adapted to rotate and normalize Wₛₜₑₚ(t) so it is aligned with and has the same magnitude as a designated reference signal.

78. The system of claim 77,
wherein the designated reference signal is the Q(t) used to determine phase angles and visibilities.

79. The system of claim 56,
further comprising processor means for preparing the data prior to numerically reversing the optical heterodyning, by performing at least one of removing warp and resampling/rebinning the data,

80. The system of claim 79,
wherein the processor means for preparing is adapted to resample/rebin by Fourier transforming the data into frequency-space, padding the right (higher frequencies) with zeros so that the maximum frequency on the right, called the Nyquist frequency, is increased, and inverse Fourier transforming back to time-space.

81. The system of claim 79,
wherein the processor means for preparing is adapted to dewarp by removing any nonlinearities in the time axis, if present, so that the modulation is perfectly sinusoidal with constant frequency across all time.

82. The system of claim 56,
further comprising processor means for rotating the treble spectrum W_{treb}(f) in phase so that it is in proper alignment with the other components, including the ordinary component and treble components from other modulation frequencies if they are used.

83. The system of claim 82,
wherein the processor means for rotating the treble spectrum is adapted to determine the amount of in-phase rotation of the treble spectrum W_{treb}(f) from a calibration measurement of a known signal that is performed by the instrument either at the same time on other recording channels, or soon after the main measurement before the instrument characteristics have time to change.

84. The system of claim 56,
further comprising processor means for deleting a comb spike and everything else at negative frequencies prior to making the treble spectrum W_{treb}(f) into the double sided spectrum S_{dbl}(f).

85. The system of claim 56,
wherein the processor means for making the treble spectrum W_{treb}(f) into the double sided spectrum S_{dbl}(f) is adapted to copy the complex conjugate of W_{treb}(f) to the negative frequency branch, and flip the frequencies so that the real valued signal S_{dbl}(t) is formed.

86. The system of claim 85,
wherein the processor means for making the treble spectrum W_{treb}(f) into the double sided spectrum S_{dbl}(f) is adapted to take the inverse Fourier transform of W_{treb}(f), set the imaginary part to zero, and then Fourier transform it back to frequency space.

87. The system of claim 56,
further comprising processor means for masking away the low frequency areas of S_{dbl}(f) where its signal is expected to be small relative to the ordinary detected spectrum S_{ord,det}(f) to delete noise, and masking away the high frequency areas of S_{ord}(f) to delete noise in frequency regions where its signal is expected to be small and noisy.

88. The system of claim 87,
wherein the processor means for masking is adapted to mask by multiplying user defined functions M_{ord}(f) and M_{beat}(f).

89. The system of claim 56,
wherein the processor means for equalizing the composite spectrum Sᵤₙ(f) is adapted to multiply Sᵤₙ(f) by an equalization shape E(f), to form the equalized composite spectrum S_{fin}(f), where the E(f) magnifies the spectrum for frequencies in a valley region between a shoulder of the ordinary spectrum and f_{M}.

90. The system of claim 89,
wherein the equalization shape E(f) is the ratio E(f)=L_{goal}(f)/L_{raw}(f) except for a toe region, and L(f) is the instrument response which is the smoothed ratio between the measured spectrum and the true spectrum.

91. The system of claim 90,
wherein L_{goal}(f) is a Gaussian function centered at zero frequency, so that the instrument lineshape in time-space, which is the Fourier transform of L_{goal}(f), has minimal ringing.

92. The system of claim 90,
wherein the L_{raw}(f) is determined through calibration measurements on a known signal, and depends on γ, D(f), f_{M}, and masking functions M_{ord}(f) and M_{beat}(f).

93. The system of claim 56,
wherein the modulation frequency f_{M} is selected to be similar to the frequency response f_{D} of the optical detector.

94. The system of claim 56,
wherein n phase-differentiated channels of sinusoidally-modulated intensity Tₙ(t) are phase shifted relative to each other by 360/n degrees.

95. The system of claim 94,
wherein n is selected from the group consisting of 3 and 4.

96. The system of claim 56,
wherein the optical detector is a multi-channel detector having a plurality of input channels assignable to different spatial locations on the target.

97. The system of claim 96,
wherein the optical detector is a streak camera.

98. A computer program product comprising:
a computer useable medium and computer readable code embodied on said computer useable medium for causing an increase in the temporal resolution of an optical detector measuring the intensity versus time of an intrinsic optical signal S₀(t) of a target having frequency f, so as to enhance the measurement of high frequency components of S₀(t) when the target is illuminated with a set of n phase-differentiated channels of sinusoidally-modulated intensity Tₙ(t), with n≧3 and modulation frequency f_{M}, to produce a corresponding set of optically heterodyned signals S₀(t)Tₙ(t), and a set of signals Iₙ(t) is detected at the optical detector which are the optically heterodyned signals S₀(t)Tₙ(t) reaching the detector but blurred by the detector impulse response D(t), expressed as Iₙ(t)={S₀(t)Tₙ(t)}\textcircled{×}D(t)=S_{ord}(t)+I_{n,osc}(t), where S_{ord}(t) is an ordinary signal component and I_{n,osc}(t) is an oscillatory component comprising a down-shifted beat component and an up-shifted conjugate beat component, said computer readable code comprising:
computer readable program code means for using the detected signals Iₙ(t) to determine an ordinary signal S_{ord,det}(t) to be used for signal reconstruction, and a single phase-stepped complex output signal Wₛₜₑₚ(t) which is an isolated single-sided beat signal;
computer readable program code means for numerically reversing the optical heterodyning by transforming Wₛₜₑₚ(t) to Wₛₜₑₚ(f) and S_{ord,det}(t) to S_{ord,det}(f) in frequency space, and up-shifting Wₛₜₑₚ(f) by f_{M} to produce a treble spectrum W_{treb}(f), where W_{treb}(f)=Wₛₜₑₚ(f−f_{M});
computer readable program code means for making the treble spectrum W_{treb}(f) into a double sided spectrum S_{dbl}(D that corresponds to a real valued signal versus time S_{dbl}(t);
computer readable program code means for combining the double sided spectrum S_{dbl}(f) with S_{ord,det}(to form a composite spectrum Sᵤₙ(f);
computer readable program code means for equalizing the composite spectrum Sᵤₙ(f) to produce S_{fin}(f); and
computer readable program code means for inverse transforming the equalized composite spectrum S_{fin}(f) into time space to obtain S_{fin}(t) which is the measurement for the intrinsic optical signal S₀(t).
